(19) United States
(12) Patent Application Publication
(10) Pub. No.: US 2006/0029807 A1
(43) Pub. Date: Feb. 9, 2006

(54) Method for the design of laminated composite materials

(76) Inventor: Scott Owen Peck, Palo Alto, CA (US)

Correspondence Address: Scott Owen Peck, 927 Maddux Drive, Palo Alto, CA, 94303-4011, US

(21) Appl. No.: 10/911,466

(22) Filed: Aug. 4, 2004

(51) Int. Cl. B32B 5/12

(52) U.S. Cl. 428/411.1

(57) ABSTRACT

The fundamental premise of designing structures with laminated composite materials is that the materials can be tailored to meet requirements by choosing the materials, thicknesses or thickness fractions, and orientation angles of constituent materials. Minimum weight, dimensional stability, natural frequency, and thermal conductivity are typical goals. This invention is NOT about the analysis of laminated materials and composites, of which there is no short supply. This invention is about the design of laminated materials, which has traditionally been an iterative event between the designer and the analysis tool. These iterations, if they occur at all, are often the most time consuming aspect of design. The fundamental premise of this invention is that tensor invariants of constituent material properties coupled with a tensor description of the specified material requirements can be used together to design laminated materials. The results of this invention can be used as a stand-alone design tool or as a value-added module in finite element codes. Specifically, by specifying material requirements, designers will use the method to select from a catalog of available materials a set that will satisfy their requirements. The designer is aided in the choice of materials, how much of each material to use, the layup angle orientation of the materials, and the sequencing of those materials in the composite laminate.

### STATEMENT REGARDING FEDERALLY SPONSORED RESEARCH OR DEVELOPMENT

This invention is based in part on work performed under a Small Business Innovation Research contract between the Missile Defense Agency and Composite Design of Palo Alto, Calif. titled “Invariant Based Design of Laminated Composite Materials”, Contract DASG60-02-P-0130 (2002).

### REFERENCES CITED

U.S. Patent

1. R. P. Reese, T. W. Gossard, Jr., “Near Zero CTE Carbon Fiber Hybrid Laminate,” U.S. Pat. No. 5,993,934, Nov. 30, 1999.
2. Vasey-Glandon et al., Knowledge Driven Composite Design Optimization Process and System Therefore, U.S. Pat. No. 6,341,261, Jan. 22, 2002.
3. Vasey-Glandon et al., Knowledge Driven Composite Design Optimization Process and System Therefore, U.S. Pat. No. 5,984,511, Nov. 16, 1999.
4. Ward, et al., Method and Apparatus for the Design and Construction of Composite Parts, U.S. Pat. No. 5,006,990, Apr. 9, 1991.
5. Ward, et al., Method for the Design and Construction of Composite Parts, U.S. Pat. No. 4,849,913, Jul. 18, 1989.
   Other References
6. D. Lovelock, H. Rund, Tensors, Differential Forms, and Variational Principals, Dover Publications 1989.
7. S. W. Tsai, H. T. Hahn, Introduction to Composite Materials, Technomic 1980.
8. R. M. Jones, Mechanics of Composite Materials, Second Edition, Taylor and Francis 1999.
9. S. W. Tsai, Theory of Composites Design, Think Composites: Dayton, Paris, and Toyko 1992.
10. S. W. Tsai, Composites Design Fourth Edition, Think Composites: Dayton, Paris, and Toyko 1988.
11. L. P. Kollar, G. S. Springer, Mechanics of Composite Structures, Cambridge University Press 2003.
12. A. L. Kalamkarov, A. G. Kolpakov, Analysis, Design and Optimization of Composite Structures, John Wiley & Sons 1997.
13. J. N. Reddy, Mechanics of Laminated Composite Plates: Theory and Analysis, CRC Press, 1997.
14. J. R. Vinson, The Behavior of Sandwich Structures of Isotropic and Composite Materials, Technomic Publishing Company, 1999.
15. ALGOR, 150 Beta Drive, Pittsburgh, Pa. 15238
16. Z. Gurdal, R. T. Haftka, P. Hajela, Design and Optimization of Laminated Composite Materials, John Wiley and Sons 1999.
17. Hypersizer™, Collier Research Corporation, 45 Diamond Hill Road, Hampton, Va. 23666.
18. CompositePro™, Peak Composite Innovations, LLC, 11372 W. Parkhill Dr., Littelton, Colo. 80127.
19. CompositEase™, Technomic Publishing Co., Inc., 851 New Holland Ave., Box 3535, Lancaster, Pa. 17604.
20. V-Lab™, Technomic Publishing Co., Inc., 851 New Holland Ave., Box 3535, Lancaster, PA 17604.
21. Global Optimization, Loehle Enterprises, Package for Mathematica.
22. S. Wolfram, The Mathematica Book, Cambridge University Press, 1996.
23. S. O. Peck, “Invariant Based Design of Laminated Composite Materials”, Final SBIR Report to the Missile Defense Agency, Contract DASG60-02-P-0130 (2002).
24. S.-K. Ha, C. Keilers, F.-K. Chang, “Analysis of Laminated Composites Containing Distributed Piezoelectric Ceramics,” First U.S./Japan Conference on Adaptive Structures, Nov. 13-15, 1990.
25. S. E. Miller, H. Abramovich, “A Self-Sensing Piezolaminated Actuator Model for Shells Using a First Order Shear Deformation Theory,” Journal of Intelligent Material Systems and Structures, Vol. 6—September 1995.
26. S. W. Tsai and N. J. Pagano, “Invariant Properties of Composite Materials,” In Composite Materials Workshop, pp. 233-253, S. W. Tsai, J. C. Halpin, and N. J. Pagono (eds.), Technomic Publishing Co., Westport.
27. J.-M. Berthelot, Composite Materials: Mechanical Behavior and Structural Analysis, Springer Verlag New York, Inc. 1999.

### BACKGROUND OF THE INVENTION

1 Field of the Invention

The present invention relates generally to a method for the design of laminated composite materials and their tensor properties.

2 Definitions

Tensors

A definition for tensors is given by Lovelock and Rund [6]. “Consider an n-dimensional Euclidean space Eₙ . . . . An orthonormal system {eⱼ} in En consists of n mutually orthogonal unit vectors. Any other orthonormal system {\overline{e}ⱼ} may be obtained from the first by means of the linear transformation

$${\overline{e}}_{j} = {\sum }_{h = 1}^{n} {a}_{jh} {e}_{h} ( j = 1 , … , n ) \qquad ( 5.2 .1 )$$

“provided that the coefficients aⱼₕ satisfy the orthogonality condition

$${δ}_{jk} = {\sum }_{h = 1}^{n} {a}_{jh} {a}_{kh} ( j , k = 1 , … , n ) \qquad ( 5.2 .2 )$$

where aⱼₖ=cos(\overline{e}ⱼ,eₖ) (5.2.3)

“The coordinates of a point P relative to the orthonormal systems {eⱼ} and {\overline{e}ⱼ} are respectively denoted by x^{j} (j=1, . . . , n) and \overline{x}^{j} (j=1, . . . , n); these coordinates are related according to the transformation equations

$${x}^{j} = {\sum }_{h = 1}^{n} {a}_{jh} {x}^{h} ( j = 1 , … , n ) \qquad ( 5.2 .4 )$$

“Let r be any positive integer. A set of n^{r} quantities Tₕ_{₁}ₕ_{₂} _{. . . h}_{ᵣ} is said to constitute the components of an affine tensor of rank r, if, under the orthogonal coordinate transformation (5.2.4), these quantities transform according to the transformation law

$${\overline{T}}_{{j}_{1} {j}_{2} ⋯ {j}_{r}} = {\sum }_{{h}_{1} = 1}^{n} {\sum }_{{h}_{2} = 1}^{n} ⋯ {\sum }_{{h}_{r} = 1}^{n} {a}_{{j}_{1} {h}_{1}} {a}_{{j}_{2} {h}_{2}} ⋯ {a}_{{j}_{r} {h}_{r}} {T}_{{h}_{1} {h}_{2} ⋯ {h}_{r}} ( {j}_{1} , {j}_{2} , … , {j}_{r} = 1 , … , n ) \qquad ( 5.2 .5 )$$

Note that the summations over indices have been explicitly expressed in (5.2.1) through (5.2.5). Subsequently, the summation convention that implies summation over repeated indices will be used. Table 1 below lists examples of tensors of varying order.

TABLE 1
Tensor examples

| Tensor rank | Name | Example |
|---|---|---|
| 0 | Scalar | Temperature, T |
| 1 | vector | Force, ƒᵢ |
| 2 | 2^{nd} order tensor | Stress, σᵢⱼ |
| 3 | 3^{rd} order tensor | Piezoelectric coupling, dᵢⱼₖ |
| 4 | 4^{th} order tensor | Elastic stiffnesses, Qᵢⱼₖₗ |

Tensor Invariants

Fundamentally, tensors [6] represent physical quantities that do not depend on the coordinate systems used to measure them. Part of that notion includes the idea that a tensor possesses invariant properties. Indicial notation and the summation convention allow easy identification of tensor invariants. A tensor expression with no free indices is a scalar quantity and therefore invariant.

Material Properties

A measure of the response of a material to an external stimulus. Intrinsic physical characteristics of materials that frequently require a tensor description.

Example second order tensor properties are selected from the group comprised of laminate thermal conductivity, laminate in-plane thermal expansion, and laminate bending thermal expansion.

Example third order tensor properties are selected from the group comprised of laminate in-plane piezoelectric effect, laminate bending piezoelectric effect, and laminate coupling piezoelectric effect.

Example fourth order tensor properties are selected from the group comprised of laminate in-plane stiffness, laminate bending stiffness, laminate coupling stiffness, sandwich structure in-plane stiffness, sandwich structure bending stiffness, sandwich structure coupling stiffness, and laminate strength.

Specified Requirements

A set of material properties, expressed in tensor form, desired or required in a laminate to be designed and manufactured.

Layup Angle

The angular orientation of a material coordinates with respect to a set of laminate coordinates.

Thickness Fraction

The thickness of a given material in a laminate divided by the total thickness of the laminate. In the case of two-dimensional laminated plates, this is equivalent to a volume fraction.

Set of Candidate Materials

A collection of materials available to a laminate designer from which specific materials will be chosen to construct the actual laminate.

Optimal Set

The set of materials, layup angles, thicknesses or thickness fractions, and stacking sequence that most closely approaches the specified requirements for the laminate.

Hybrid Laminate

A laminate constructed from two or more different materials.

Stacking Sequence

The ordering of materials within the laminate from bottom to top.

3. Prior Art

Classical Laminated Plate Theory

Classical laminated plate theory is well developed in the literature (e.g. Tsai and Hahn [7], Jones [8], Tsai [9, 10], Kollar and Springer [11], Reddy [13] and many others). Laminated plate theory has also been captured in a number of computer programs including HyperSizer™ [17], CompositePro™ [18], CompositEase™ [19], V-Lab [20], and others. The following will serve as a very brief overview of some of the important relationships and concepts. Recall this patent is not about a new theory of laminated plate behavior. Rather, it is about a new method of designing laminated plates.

Laminates

A laminated plate is composed of layers of materials that are bonded together to form the final product. Each material may have its own unique set of material properties which are tensorial in nature. In general the material properties will vary with the orientation of the material. That is, the material properties are anisotropic. In order to analyze the behavior of the laminate, the material properties of each layer must be rotated into a common frame of reference for the laminate in order to develop the properties of the plate. The behavior of the plate is based on the assumption that each layer contributes to the behavior of the whole in proportion to its thickness fraction of the whole. FIG. 1 illustrates a set of available generally anisotropic materials from which some are selected to fabricate the final laminate.

Stress-Strain Relations for Anisotropic Materials

The generalized form of Hooke's Law for anisotropic materials in plane stress is given in Equation (5.3.1), where the stress σᵢⱼ is linearly related to strain εₖₗ by the plane stress reduced elastic stiffnesses Qᵢⱼₖₗ. Stress and strain are both second order tensors (as indicated by the double subscript), whereas the elastic stiffnless is a fourth order tensor (four subscripts). The summation convention applies, repeated subscripts implying summation. The range of the subscripts is from 1 to 2 since laminated plates are considered to be two-dimensional objects.
σᵢⱼ=Qᵢⱼₖₗεₖₗ i,j,k,l=1,2 (5.3.1)
Rotation of Stress, Strain, and Elastic Stiffnesses

The relationship between two orthogonal Cartesian coordinate systems rotated by an angle θ with respect to one another may be described by the rotation matrix (5.2.3)

$${a}_{ij} = ( \begin{matrix}cos θ & sin θ \\ - sin θ & cos θ\end{matrix} ) \qquad ( 5.3 .2 )$$

FIG. 2 illustrates the relationship between a coordinate system oriented with respect to the laminated plate and a coordinate system oriented with respect to the material constituting a given layer.

The components of the stress, strain, and elastic stiffness tensors in a common coordinate system for the plate (indicated by an overbar) are obtained from the original tensor components and the rotation matrix by the following transformations. Again, the summation convention is implied.
\overline{σ}ᵢⱼ=aᵢₖaⱼₗσₖₗ
\overline{ε}ᵢⱼ=aᵢₖaⱼₗεₖₗ
\overline{Q}ᵢⱼₖₗ=aᵢₚa_{jq}aₖᵣaₗₛQ_{pqrs} (5.3.3)

Classical Plate Theory Strain Assumption

The strains in classical plate theory are assumed to be a sum of the midplane strain εᵢⱼ⁰ plus a contribution due to bending that is linearly proportional to the distance from the midplane z and the curvature κᵢⱼ.
εᵢⱼ=εᵢⱼ⁰+zκᵢⱼ (5.3.4)
Laminated Plate Theory

Force Nᵢⱼ and moment Mᵢⱼ resultants for the plate are obtained by integrating Equation (5.3.1), the stress-strain relation, together with the strain assumption Equation (5.3.4), yielding

$${N}_{ij} = {\int }_{- t / 2}^{t / 2} {\overline{σ}}_{ij} ⅆ z = {\int }_{- t / 2}^{t / 2} {\overline{Q}}_{ijkl} ( {ɛ}_{kl}^{0} + z {κ}_{kl} ) ⅆ z = {A}_{ijkl} {ɛ}_{kl}^{0} + {B}_{ijkl} {κ}_{kl} \\ {M}_{ij} = {\int }_{- t / 2}^{t / 2} {\overline{σ}}_{ij} z ⅆ z = {\int }_{- t / 2}^{t / 2} {\overline{Q}}_{ijkl} ( {ɛ}_{kl}^{0} + z {κ}_{kl} ) z ⅆ z = {B}_{ijkl} {ɛ}_{kl}^{0} + {D}_{ijkl} {κ}_{kl} \qquad ( 5.3 .5 )$$

The stiffnesses of the laminated plate are characterized by

$${A}_{ijkl} = {\sum }_{m = 1}^{N} {\overline{Q}}_{ijkl}^{m} ( {z}^{m} - {z}^{m - 1} ) \\ {B}_{ijkl} = \frac{1}{2} {\sum }_{m = 1}^{N} {\overline{Q}}_{ijkl}^{m} ( {( {z}^{m} )}^{2} - {( {z}^{m - 1} )}^{2} ) i , j , k , l = 1 , 2 \\ {D}_{ijkl} = \frac{1}{3} {\sum }_{m = 1}^{N} {\overline{Q}}_{ijkl}^{m} ( {( {z}^{m} )}^{3} - {( {z}^{m - 1} )}^{3} ) \qquad ( 5.3 .6 )$$

The superscript m has been added to distinguish individual layers of material. The total number of layers is N. The z^{m} are elevations from the laminate midplane. The Aᵢⱼₖₗ are in-plane extensional stiffnesses, Dᵢⱼₖₗ are out-of-plane bending stiffnesses, and Bᵢⱼₖₗ are bending-extension coupling stiffnesses. In this notation subscripts indicate the tensor nature of an object while superscripts are associated with the position or order of a ply within a laminate and do not indicate tensor character. Ordinary powers are indicated by enclosing parentheses. FIG. 3 shows a side view through the thickness of a laminate with the thicknesses of each layer t^{m}, the total thickness t, and the coordinates or elevations z^{m} of the layers with respect to the laminate midplane.

Laminate Specific Properties

The specific stiffness properties of a laminated plate are defined by dividing appropriate multiples of the overall plate thickness h as follows.

$${\hat{A}}_{ijkl} = \frac{1}{h} {\sum }_{m = 1}^{N} {\overline{Q}}_{ijkl}^{m} ( {z}^{m} - {z}^{m - 1} ) \\ {\hat{B}}_{ijkl} = \frac{1}{2 {h}^{2}} {\sum }_{m = 1}^{N} {\overline{Q}}_{ijkl}^{m} ( {( {z}^{m} )}^{2} - {( {z}^{m - 1} )}^{2} ) i , j , k , l = 1 , 2 \\ {\hat{D}}_{ijkl} = \frac{1}{3 {h}^{3}} {\sum }_{m = 1}^{N} {\overline{Q}}_{ijkl}^{m} ( {( {z}^{m} )}^{3} - {( {z}^{m - 1} )}^{3} ) \qquad ( 5.37 )$$

A caret over the tensor symbol will be used to indicate specific rather than structural properties. Both can be designed by the methods described herein.

Laminate Material Properties

The stiffness tensors Aᵢⱼₖₗ, Bᵢⱼₖₗ, Dᵢⱼₖₗ and Âᵢⱼₖₗ, \hat{B}ᵢⱼₖₗ, \hat{D}ᵢⱼₖₗ describe the mechanical behavior and specific behavior of a laminate, respectively. These tensors are some of the objects that will be designed by the new method described in this patent, but in the current state of the art are simply calculated based on a laminate description. Other laminate properties which can be calculated include, but are not limited to, thermal conductivity kᵢⱼ and thermal expansion properties αᵢⱼ.

Laminate Design State-of-the-Art

The current design of laminated composite materials and structures made of laminated composite materials generally follows a sequence of designing a part followed by analysis. In many companies these functions are carried out by separate groups. Part design generally means meeting geometric requirements. Material choice is often based on heritage, meaning using what worked in the past. In the case of metal design, analysis relationships can sometimes be inverted to find required thicknesses of materials. However, in the case of laminated composite materials, this approach simply doesn't work because there are too many variables and not enough equations [8]. Since laminate properties are nonlinear functions of layup angles, it has been difficult to know in advance whether the chosen material(s) will work, how much of each material to use, and how to orient the materials within the laminate. If the analysis indicates that the design doesn't work, then the part must be redesigned and analyzed again. This sequence is summarized in Table 2.

TABLE 2
Current Laminate Design and Analysis Sequence

| Step | Action | Notes |
|---|---|---|
| 1 | Select materials | Usually heritage based selection. |
| 2 | Select thicknesses and | Again, heritage. |
| | stacking sequence | |
| 3 | Select layup angles | Often quasi-isotropic or limited to 0, 45, −45, 90 angles |
| 4 | Laminate analysis | Rotate material properties and calculate effective laminate |
| | | properties using classical plate theory. |
| 5 | Evaluate performance | If unsuitable, return to step one and iterate. |

Design and Optimization of Laminated Plates
Laminate Ranking

Tsai [9, 10] discusses the design of laminates through a process known as laminate ranking. Essentially, an exhaustive listing of all possible laminates of various angle layup possibilities are calculated and then compared or ranked in a spreadsheet. Only a single material is considered for the laminate and the material selection is made a priori. Laminates generally contain layers of 0, 45, −45, and 90 degree oriented material where the integer number of plies of each orientation is allowed to vary. Laminates are ranked based on individual components of the tensor properties calculated, for example the stiffness or strength in one direction. The method is based on laminated plate theory for families of symmetric laminates subjected to in-plane loads only.

This method differs from the present method in that it does not address the requirements of the material, does not select materials for the laminate, does not find a tensor based solution, and does not find layup angles directly.

Optimization of Laminated Composite Materials

A number of computer codes exist that optimize composite laminates [17, 18, 19, 20]. All do not consider material selection as one of the parameters. The rest treat layup angles and ply thicknesses as a combined parameter set. Some treat the variables as continuous, while others consider the variables as discrete. Genetic algorithms are used as are standard optimization routines. Most all optimize with respect to a set of applied loads rather than with respect to a desired set of material properties as described here.

Gurdal et al [16] described laminate optimization schemes. The examples shown, in general, assume that laminates are constructed of one material, that the material selection has been made a priori, and that the primary variables are layup angles, thicknesses, and stacking sequence. The optimizations tend to focus on optimizing specific components of the tensor objects rather than the whole tensor. Layup angles are typically restricted to 0°, 45°, −45°, 90°. Use of the material parameters U₁, U₂, U₃, U₄, U₅ originally identified by Tsai and Pagano [26] is made. Although most authors correct the notion, these parameters have been incorrectly labeled “invariant” in the literature. Only two are truly invariant in the tensor sense.

Kalamkarov and Kolpakov [12] address the problem of designing laminated composite materials composed of a number of different materials. In examples where hybrid laminates are designed, the constituent materials are always isotropic. In the example where anisotropic fiber reinforced materials are used, only one fiber reinforced material is used to construct the laminate, and the design variable is the number of layup angles required. The analyses presented appear to be of kind of netting analysis, where the only fiber dominated materials properties are considered. The authors mention once the problem of designing a hybrid composite laminated, but only establish it a problem to be solved and provide no examples.

Patent Literature

Reese et al [1] describe a method for the design of composite material laminates for near zero coefficients of thermal expansion (CTE): “The most efficient method for determining the appropriate stacking sequence, ply angles, and ply thicknesses to meet the CTE goals defined . . . is to first assume a quasi-isotropic, symmetric layup for each fiber/resin combination selected. Lamination theory is then used to determine the in-planes CTEs . . . . If the goals are met, then the process is complete . . . However, if the goals are not met, then first alter the ply angles . . . and repeat the lamination theory analysis until the design goals are met. If altering the ply angles does not yield the desired results, then the ply thicknesses must be changed . . . and the process repeated until the design goals are met.” In other words, assume what is arguably [2] the worst possible laminate as a starting point, and then do either an exhaustive search or random walk from there until a design is found. Unfortunately, this method of laminate design is the de facto industry standard.

Vasey-Glandon et al [2, 3] describe a “knowledge driven composite design optimization process for designing a laminated part,” specifically “a globally optimized 3-D ply definition for a laminate part.” Although similar sounding to the current work, the focus of the patent is on 3-D part definitions and the relationship of parts to one another, not the local design of the laminate itself. Furthermore, the user is still required to select material, thicknesses and layup angles. In fact, the user is limited to four distinct layup angles: “Preferably, the laminate family includes plies oriented at up to four orientations: zero, ninety; forty-five and negative forty-five degrees from their defined zero axis, which is defined in the FEA data.”

Ward et al [4, 5] describe a “method and apparatus for the design and construction of composite parts,” which while also sounding similar to the present work, is in fact a method for the description of composite parts such that the data can be integrated with computer aided design systems and tool path computer programs. The method does not discuss the actual design of the composite part in terms of material selection, thickness fractions, or layup angle determinations.

Commercial Finite Element Program

Most commercial finite element programs have laminated plate and shell elements in their analysis capabilities. Many have made substantial progress in certain aspects of design, most notably shape optimization. Others offer laminate optimization routines that find layup angles and volume fractions for a given choice of materials. None, however, offer true design capabilities for materials as described here. Typically, these codes include a catalog of materials that users may choose from or add to if desired. However, the choice of materials, amounts, and layup angles is left to the analyst. A screen shot of an Algor [15] finite element analysis of a simple laminated composite plate is shown in FIG. 4. At this point, the geometry of the plate and the imposed loads have been determined. The next step for the analyst is to specify the materials for the plate. In this particular example, the analyst would choose “Element Definition” from the left hand tree structure to bring up the screen shown in FIG. 5.

The Element Definition screen requires the analyst to choose the thicknesses, lamina orientation angles, and materials (in the example generically referred to as “composite”) for the laminate. Notice that no help is offered in these choices. This is typical of finite element codes and laminate analysis in general.

### BRIEF SUMMARY OF THE INVENTION

Purpose

A laminated composite material is composed of one or more layers of material bonded together perfectly. The material properties of each layer admit a tensor description. The orientation of each layer with respect to the laminate is described by a layup angle. Each layer has a certain thickness, and the relative amount of each layer with respect to the overall thickness of the laminate is described by a thickness fraction, and the ordering of each layer within the laminate is described by a stacking sequence. The number of layers of material will, in general, exceed the number of materials used in the laminate.

This invention describes a method for efficient design of a specified laminated composite material having tensor properties. The specified requirements are, in general, derived from a requirements flowdown for the part or structure containing the laminated composite material. The requirements specify the components of the material property tensor(s) desired in the final laminate. A set of candidate materials having tensor properties is assumed to exist. The design problem thus becomes one of choosing an optimal set of materials and associated thicknesses or thickness fractions, layup angles, and material stacking sequence.

Tensor Invariants

Fundamentally, tensors [6] represent physical quantities that do not depend on the coordinate systems used to measure them. Part of that notion includes the idea that a tensor possesses invariant properties. Indicial notation and the summation convention allow easy identification of tensor invariants. A tensor expression with no free indices is invariant. The first order tensor expression fᵢ, the second order tensor kᵢⱼ, and the fourth order tensor Aᵢⱼₖₗ all contain free indices and are not invariant. Consider, however, tensor expressions such as kᵢᵢ, Aᵢⱼᵢⱼ, and kᵢⱼkᵢⱼ which contain no free indices and are all therefore tensor invariants. An invariant tensor expression which contains only one term, for example kᵢᵢ, is known as a linear invariant. If the expression contains two terms, for example kᵢⱼkᵢⱼ, it is known as a quadratic invariant.

Laminate Feasibility

Equating the linear invariant(s) of the specified laminated composite material with the linear invariant(s) of a laminate of candidate materials establishes the necessary conditions for feasibility of the laminate. Note that if the number of candidate materials in the laminate is limited to one, then this equation will evaluate to either true or false. That is, either exactly the right material has been chosen to meet the requirements or it hasn't. However, if the number of materials is allowed to increase to at least one more than the number of linear invariants, then a design space has been created. Together with a physically realistic requirement that thickness fractions fall between zero and one, sufficient linear equations are available to evaluate all possible combinations of candidate material sets for feasibility against the design requirements.

Mathematically, the use of linear invariants separates the linear variables (thickness fractions, candidate material selection) from the nonlinear variables (layup angles). The feasibility of a laminate is thus established as a linear problem. Although the final laminate design will still require layup angles, as discussed below, the difficulty of solving the remaining nonlinear problem has been substantially reduced.

Some material design problems, most notably thermal expansion, involve two material properties simultaneously. For example, laminate thermal expansion involves both the thermal expansion of the individual layers and the stiffness properties of the individual layers. Furthermore, solutions to these kinds of problems generally involve inverting the stiffness tensor of the laminate. These issues tend to complicate the feasibility solutions proposed.

Layup Angles

Finding layup angles is an inherently nonlinear problem. Therefore, an exact solution to the specified laminate design problem may not be realizable. Minimizing the quadratic invariant of the difference between the specified laminate and the candidate laminate with respect to layup angles will find the best overall laminate for a given set of candidate materials and thickness fractions. The quadratic invariant is also known as the tensor norm. The norm is a nonlinear scalar function of layup angles due to cross products between different layers or materials. The design problem can be nondimensionalized by dividing the objective function by the tensor norm of the specified laminate.

Additional layers and associated layup angles can be added within materials. However, the number of layup angles is limited by the quasi-isotropic conjecture, which states that the number of layup angles per material need not exceed the number of layup angles to create a quasi-isotropic material for the tensor property being designed. Minimization of the quadratic invariant will find layup angles for laminates of multiple layers per candidate material.

Layup Angles and Thickness Fractions Simultaneously

For design problems involving inversion of the stiffness tensor, finding thickness fractions and layup angles simultaneously through minimization of the tensor norm can be the best strategy. It is also possible to adopt this strategy even after feasible laminates have been found using the linear tensor invariants. In some cases, improved solutions can be found.

Stacking Sequences

Design problems involving bending imply that the sequence of layers and materials within the composite material is important. Again, equating the linear invariant(s) of the specified laminated composite material with the linear invariant(s) of a laminate of candidate materials establishes the necessary conditions for feasibility of the laminate. Mathematically, the use of linear invariants separates the linear variables (candidate material selection) from the nonlinear variables (layup angles), although the equations may be cubic (in the case of bending stiffness, for example) in coordinate locations of the layers. However, cubic equations are easily solvable. Physical restrictions on coordinates (must be positive with respect to the bottom surface, for example) allow identification of feasible solutions incorporating the candidate stacking sequence.

Summary: A Strategy for Design

This patent is about a method for the design of new laminated composite materials. The method improves on current state-of-the-art trial and error methods by selecting materials based on establishing a relationship between the tensor invariants of candidate materials and the tensor invariants of design requirements. The same relationships are shown to establish the required thicknesses or thickness fractions of the selected materials, again in contrast to the current state-of-the-art where thicknesses or thickness fractions are selected either based on heritage designs or by time consuming trial and error. The method further improves on current trial and error methods for finding laminate layup angles by minimizing the tensor norm of the difference between the candidate laminate and the specified laminate tensor requirements. The new method steps are summarized in Table 3.

TABLE 3
New Method for Laminated Composite Material Design

| Step | Action | Notes |
|---|---|---|
| 1 | Establish specified new material requirements. | Stiffliess, thermal expansion, |
| | | thermal conductivity |
| 2 | Calculate tensor invariants of the specified | Linear invariants. |
| | laminated composite material and of the candidate | |
| | materials. | |
| 3 | Equate the invariants and solve for thicknesses or | Linear/combinatorial problem. |
| | thickness fractions, a set of candidate materials, and | Cubic for stacking sequence. |
| | stacking sequence. | |
| 4 | Find layup angles by minimizing the tensor norm of | Nonlinear minimization. |
| | the difference between the specified and the | |
| | candidate laminate. | |
| 5 | If necessary, simultaneously find thicknesses or | Stiffness inversion required for |
| | thickness fractions and layup angles for certain | solution. |
| | design problems. | |
| 6 | If desired, improve the solution by adding layers | Additional layup angles limited by |
| | within materials. | quasi-isotropic conjecture. |

### BRIEF DESCRIPTION OF THE DRAWINGS

FIG. 1 Candidate materials selected and then bonded together to form a laminate.

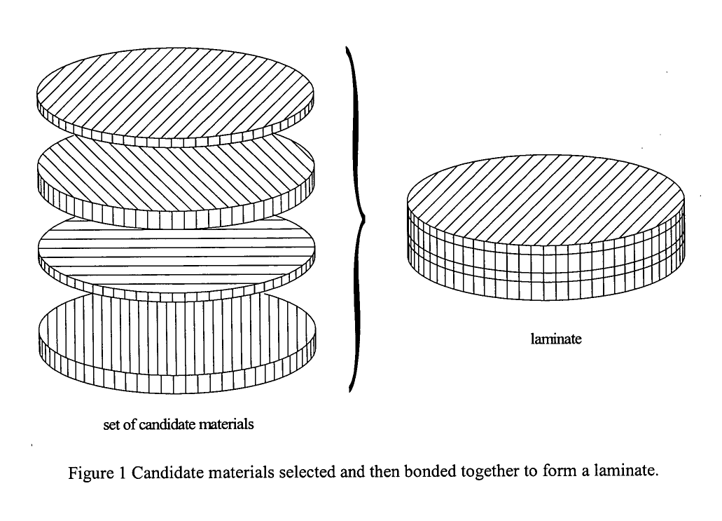

FIG. 2 Orientation of material with respect to plate and ply coordinates

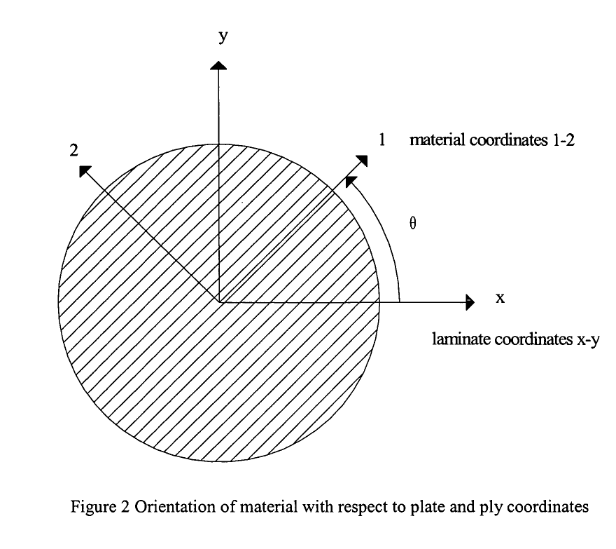

FIG. 3 Thicknesses and coordinates of material layers in a laminate

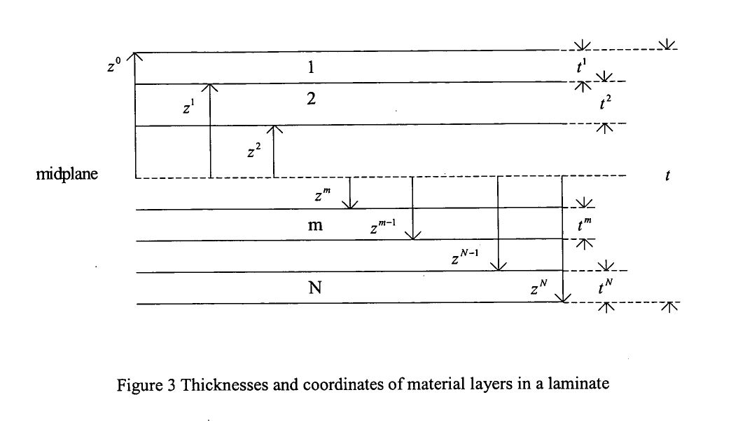

FIG. 4 Algor [10] finite element analysis of a composite laminated plate.

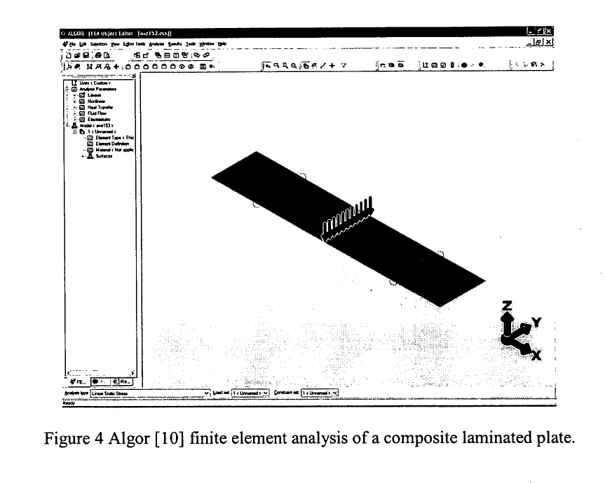

FIG. 5 Algor Element Definition for a Thick Composite Material

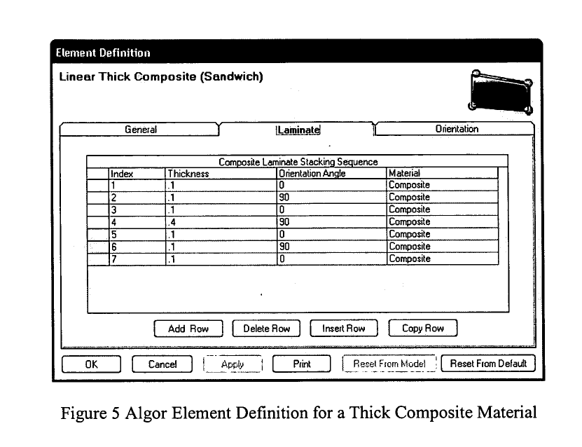

FIG. 6 Optimization surface of

$$\sqrt{\frac{( {D}_{ijkl}^{spec} - {D}_{ijkl}^{sand} ) ( {D}_{ijkl}^{spec} - {D}_{ijkl}^{sand} )}{{D}_{ijkl}^{sand} {D}_{ijkl}^{sand}}}$$

FIG. 7 Contour plot of surface (0.1 fraction contours)

FIG. 8 Contour plot detail (0.05 fraction contours)

FIG. 9 Laminate Design Wizard Interface

### DETAILED DESCRIPTION OF THE INVENTION

Detailed Description of the Preferred Embodiments

The following examples illustrate the use of invariant based design principles in the design of laminated composite materials, wherein the laminate tensor properties are selected from the group consisting of second order tensor properties, third order tensor properties and fourth order tensor properties. Those skilled in the art will realize that the methods described herein can be also be used in the design of laminated materials possessing similar tensor properties not covered in the examples. Furthermore, it is clear that this design strategy can be extended to tensor properties of higher order as well.

Thermal Conductivity

Design Objective

Thermal conductivity kᵢⱼ is a second order tensor material property as is evident from the basic heat transfer relation. The objective is to design a laminate with specified thermal conductivity from a catalog of available candidate materials.

Rotation of the components of the thermal conductivity tensor from one coordinate system to another by an angle θ is accomplished through

$$\begin{matrix}{\overline{k}}_{ij} = {a}_{ik} {a}_{jl} {k}_{kl} & ( 8.2 .1 ) \\ {a}_{ij} = ( \begin{matrix}Cos θ & Sin θ \\ - Sin θ & Cos θ\end{matrix} ) & ( 8.2 .2 )\end{matrix}$$

where aᵢⱼ is the matrix of direction cosines and the overbar on the thermal conductivity tensor indicates the components of the tensor after rotation into a coordinate system common to the laminate. The specific thermal conductivity of the laminate is calculated from

$${\hat{k}}_{ij}^{lam} = {\sum }_{m = 1}^{N} {\overline{k}}_{ij}^{m} {v}^{m} = {\sum }_{m = 1}^{N} {a}_{ik}^{m} {a}_{jl}^{m} {k}_{kl}^{m} {v}^{m} \\ {\sum }_{m = 1}^{N} {v}^{m} = 1 \qquad ( 8.2 .3 )$$

where v^{m} is the thickness fraction of an individual ply, and the superscript m refers to the number of the ply and does not indicate a tensor character. The total number of plies is N, which implies that the total number of materials used may also be N, but may also be fewer. Obviously, associated with each material is a set of unique material properties, in this case the thermal conductivities. The thickness fraction of an individual ply is just the actual thickness t^{m} divided by the total thickness of the laminate h.

$${v}^{m} = \frac{{t}^{m}}{h} 0 \leq {v}^{m} \leq 1 \\ h = {\sum }_{m = 1}^{N} {t}^{m} \qquad ( 8.2 .4 )$$

To design a laminate for thermal conductivity, the specified requirements for the laminate are first established, here for the 2D case, as

$${\hat{k}}_{ij}^{spec} = \{ \begin{matrix}{\hat{k}}_{11}^{spec} & {\hat{k}}_{12}^{spec} \\ {\hat{k}}_{12}^{spec} & {\hat{k}}_{22}^{spec}\end{matrix} \} \qquad ( 8.2 .5 )$$

where \hat{k}₁₁^{spec}, \hat{k}₁₂^{spec} and \hat{k}₂₂^{spec} are numerical values. The first invariant of the specified laminate is calculated from
\hat{k}ᵢᵢ^{spec}=\hat{k}₁₁^{spec}+\hat{k}₂₂^{spec} (8.2.6)

Next, the first invariant of a laminate constructed from candidate materials is calculated by

$${\hat{k}}_{ii}^{lam} = {\sum }_{m = 1}^{N} {\overline{k}}_{ii}^{m} {v}^{m} = {\sum }_{m = 1}^{N} {a}_{ik}^{m} {a}_{il}^{m} {k}_{kl}^{m} {v}^{m} = {\sum }_{m = 1}^{N} {δ}_{kl}^{m} {k}_{kl}^{m} {v}^{m} = {\sum }_{m = 1}^{N} {k}_{ii}^{m} {v}^{m} \qquad ( 8.2 .7 )$$

where the orthogonality of the rotation tensor aᵢⱼ has been used, δᵢⱼ is the Kronecker delta, and dummy subscripts have been replaced. The first invariant of the laminate is a rule-of-mixtures function of the first invariants of the constituent materials, which makes intuitive sense. More importantly, there is no dependence on the rotation matrix aᵢⱼ. Equating the first invariant of the specified laminate to the first invariant of the candidate laminate, and noting that the thickness fractions must sum to one by definition, yields two linear equations for the design of the laminate.

$${\hat{k}}_{ii}^{spec} = {\hat{k}}_{ii}^{lam} \\ {\sum }_{m = 1}^{N} {v}^{m} = 1 \qquad ( 8.2 .8 )$$

For the case where the number of materials N equals 2, Equations (8.2.8) can be uniquely solved for the thicknesses fractions required to achieve the specification. If the thickness fractions are both positive and between zero and one, then the specified laminate is feasible for the given constituents. The advantage of this formulation is that feasibility is determined before a search for layup angles is done, and the feasibility is determined through a linear relation between volume fractions and first invariants of the goal laminate and constituent materials. Furthermore, it can be argued that no more than two materials are all that are necessary to create a laminate of any thermal conductivity, provided of course, that appropriate constituent materials exist.

The layup angles for each material are found by minimizing the tensor norm of the difference between the specified laminate and candidate laminate thermal conductivities. The square root of this quantity is the “length” of the difference between the goal and the laminate. Minimizing this quantity with respect to the variables (θ^{m}, t^{m}) will give an optimum solution in a tensor sense.
min(\hat{k}ᵢⱼ^{spec}−\hat{k}ᵢⱼ^{lam})(\hat{k}ᵢⱼ^{spec}−kᵢⱼ^{lam}) (8.2.9)

The thickness fractions were used to reduce the number of variables Equation (8.2.9). The reduced nonlinear optimization problem is solved for the actual layup angles. In summary, the use of invariants (a) establishes a linear problem for thickness fractions of materials and design feasibility, and (b) establishes a reduced nonlinear optimization problem for layup angles in terms of the tensor norm.

Numerical Example

The specified conductivity of a desired laminate is given as

$${\hat{k}}_{ij}^{spec} = \{ \begin{matrix}250 & 10 \\ 10 & 25\end{matrix} \} \frac{W}{m - K} \qquad ( 8.2 .10 )$$

Consider the thermal conductivity of two candidate materials

$${k}_{ij}^{1} = \{ \begin{matrix}500 & 0 \\ 0 & 1\end{matrix} \} \frac{W}{m - K} \\ {k}_{ij}^{2} = \{ \begin{matrix}45 & 0 \\ 0 & 1\end{matrix} \} \frac{W}{m - K} \qquad ( 8.2 .11 )$$

Setting the first invariant of the specified laminate equal to the first invariant of the candidate laminate yields
275=501v¹+46v² (8.2.12)
which, together with requiring that the volume fractions sum to one, is solvable for the thickness fractions as
v¹=0.503 v²=0.497 (8.2.13)

The thickness fractions are between zero and one, indicating that a feasible solution exists. The layup angles are now found by minimizing the tensor norm invariant of the difference between the specified laminate and the candidate laminate, Equation (8.2.9). Substituting the thickness fractions determined in Equation (8.2.13) reduces the optimization problem variables from four to two, θ¹ and θ². The nonlinear two variable problem is solved by a global optimization routine [21, 22] yielding a solution
(θ¹=2.5°, θ²=−87.5°) (8.2.14)

Using these layup angles the specified and candidate laminates can now be compared.

$${\hat{k}}_{ij}^{spec} = \{ \begin{matrix}250 & 10 \\ 10 & 25\end{matrix} \} \frac{W}{m - K} \\ {\hat{k}}_{ij}^{lam} = \{ \begin{matrix}252 & 10 \\ 10 & 23\end{matrix} \} \frac{W}{m - K} \qquad ( 8.2 .15 )$$

Laminate Specific In-Plane Stiffness
Design Objective

The specific in-plane stiffness Âᵢⱼₖₗ^{lam} is a fourth order tensor property of a laminate. The objective is to design a laminate with specified properties from a catalog of candidate materials. Laminate in-plane stiffness, Equation (5.3.7), is calculated from

$${\hat{A}}_{ijkl}^{lam} = \frac{1}{h} {\sum }_{m = 1}^{N} {\overline{Q}}_{ijkl}^{m} ( {z}^{m} - {z}^{m - 1} ) i , j , k , l = 1 , 2 \qquad ( 8.3 .1 )$$

The specified components Âᵢⱼₖₗ^{spec} are given in below in a column format although it is understood that this is a fourth-order tensor property.

$${\hat{A}}_{ijkl}^{spec} = \{ \begin{matrix}{\hat{A}}_{1111}^{spec} \\ {\hat{A}}_{1112}^{spec} \\ {\hat{A}}_{1122}^{spec} \\ {\hat{A}}_{1212}^{spec} \\ {\hat{A}}_{1222}^{spec} \\ {\hat{A}}_{2222}^{spec}\end{matrix} \} \qquad ( 8.3 .2 )$$

There are two linear invariants of fourth order tensors given the symmetry properties of elastic stiffnesses.
Âᵢⱼᵢⱼ^{spec}=Â₁₁₁₁^{spec}+2Â₁₂₁₂^{spec}+Â₂₂₂₂^{spec}
Âᵢᵢⱼⱼ^{spec}=Â₁₁₁₁^{spec}+2Â₁₁₂₂^{spec}+Â₂₂₂₂^{spec} (8.3.3)

Similarly, the linear invariants of the candidate laminate are

$${\hat{A}}_{ijij}^{lam} = {\hat{A}}_{1111}^{lam} + 2 {\hat{A}}_{1212}^{lam} + {\hat{A}}_{2222}^{lam} = \frac{1}{h} {\sum }_{m = 1}^{N} ( {Q}_{1111}^{m} + 2 {Q}_{1212}^{m} + {Q}_{2222}^{m} ) {t}^{m} \\ {\hat{A}}_{iijj}^{lam} = {\hat{A}}_{1111}^{lam} + 2 {\hat{A}}_{1122}^{lam} + {\hat{A}}_{2222}^{lam} = \frac{1}{h} {\sum }_{m = 1}^{N} ( {Q}_{1111}^{m} + 2 {Q}_{1122}^{m} + {Q}_{2222}^{m} ) {t}^{m} \qquad ( 8.3 .4 )$$

Setting the invariants of the specified requirements equal to the invariants of the laminate creates three linear equations including the thickness fraction requirement, which can be solved for the required thickness fractions.

$${\hat{A}}_{ijij}^{spec} = {\hat{A}}_{ijij}^{lam} \\ {\hat{A}}_{iijj}^{spec} = {\hat{A}}_{iijj}^{lam} \\ {\sum }_{m = 1}^{N} {v}^{m} = 1 where {v}^{m} = \frac{{t}^{m}}{h} \qquad ( 8.3 .5 )$$

Notice that if N is the number of plies of a single material, these equations are either true or false and of limited use. However, if N is identified as the number of materials used in creating a laminate, then we have an equation useful for the design of new materials. For the case N=3 equations (8.3.5) can be solved exactly for the required thickness fractions of each material. To be a feasible solution, the thickness fractions must all be positive and between zero and one. It can be argued that, in the case of in-plane stiffnesses, only three materials are necessary to achieve the goal stiffness so long as they satisfy the invariant relations.

Layup angles are found once a feasible design has been established. The best overall laminate will be the one that minimizes the tensor norm invariant of the difference between the specified tensor and the candidate laminate. This is the same concept as minimizing the length of a vector, only extended to higher order tensor objects. The norm is a nonlinear scalar function of layup angles due to cross products between different materials. Layup angles can be found by minimizing:

$$min \frac{( {\hat{A}}_{ijkl}^{spec} = {\hat{A}}_{ijkl}^{lam} ) ( {\hat{A}}_{ijkl}^{spec} = {\hat{A}}_{ijkl}^{lam} )}{{\hat{A}}_{ijkl}^{spec} {\hat{A}}_{ijkl}^{spec}} \qquad ( 8.3 .6 )$$

Dividing by the norm of the goal serves to nondimensionalize the problem so that different cases can be compared. The square root of Equation (8.3.6) can also be used as a measure of “length.”

Numerical Example

The objective is to design a laminate with the following specified stiffnesses:

$$\{ \begin{matrix}{\hat{A}}_{1111}^{spec} = 80 \\ {\hat{A}}_{1112}^{spec} = 0 \\ {\hat{A}}_{1122}^{spec} = 2 \\ {\hat{A}}_{1212}^{spec} = 4 \\ {\hat{A}}_{1222}^{spec} = 0 \\ {\hat{A}}_{2222}^{spec} = 40\end{matrix} \} GPa \qquad ( 8.3 .7 )$$

Consider that three candidate materials with the following properties exist:

$$T300 E \text{-} glass Kevlar \text{49} \\ \{ \begin{matrix}{Q}_{1111}^{1} = 181.8 \\ {Q}_{1112}^{1} = 0 \\ {Q}_{1122}^{1} = 2.90 \\ {Q}_{1212}^{1} = 7.17 \\ {Q}_{1222}^{1} = 0 \\ {Q}_{2222}^{1} = 10.35\end{matrix} \} GPa \{ \begin{matrix}{Q}_{1111}^{2} = 39.2 \\ {Q}_{1112}^{2} = 0 \\ {Q}_{1122}^{2} = 2.18 \\ {Q}_{1212}^{2} = 4.14 \\ {Q}_{1222}^{2} = 0 \\ {Q}_{2222}^{2} = 8.39\end{matrix} \} GPa \{ \begin{matrix}{Q}_{1111}^{3} = 76.6 \\ {Q}_{1112}^{3} = 0 \\ {Q}_{1122}^{3} = 1.89 \\ {Q}_{1212}^{3} = 2.30 \\ {Q}_{1222}^{3} = 0 \\ {Q}_{2222}^{3} = 5.55\end{matrix} \} GPa \qquad ( 8.3 .8 )$$

That is, the goal is to design a laminate that is twice as stiff in one direction as the other is, a feature that none of the constituent materials have. Setting the two first invariants of the goal equal to the first invariants of the laminate yields
124=195.95v¹+51.95v²+85.93v³
128=206.49v¹+55.87v²+86.75v³
1=v¹+v²+v³ (8.3.9)

Together with the thickness fraction relation equations (8.3.9) can be solved explicitly for the required thickness fractions for a feasible solution
v¹=0.37 v²=0.10 v³=0.53 (8.3.10)

Note that these thickness fractions are all positive and between one and zero indicating that the candidate materials constitute a feasible design. The thickness fractions are then used to reduce the tensor norm invariant of the difference between the goal and the laminate, Equation (8.3.6), to a function of the three layup angles (θ¹, θ², θ³), which will not be shown here in the interests of brevity. A robust global optimization [7] of the function yields a solution
(θ¹=0, θ²=0, θ³=90) (8.3.11)
which leads to this result for the final laminate:

$$\{ \begin{matrix}{\hat{A}}_{1111}^{lam} = 74.4 \\ {\hat{A}}_{1112}^{lam} = 0 \\ {\hat{A}}_{1122}^{lam} = 2.3 \\ {\hat{A}}_{1212}^{lam} = 4.3 \\ {\hat{A}}_{1222}^{lam} = 0 \\ {\hat{A}}_{2222}^{lam} = 45.1\end{matrix} \} GPa \qquad ( 8.3 .12 )$$

Notice that this optimization did not yield an exact match to the goal. Despite the fact that there are six design quantities and six variables, the nonlinear nature of the design problem does not guarantee an exact solution. Thus, treatment as an optimization problem is reasonable.

Laminate Bending Stiffness

Design Objective

The bending stiffness Dᵢⱼₖₗ^{lam} is a fourth order tensor property of a laminate. The objective is to design a laminate with specified properties from a catalog of candidate materials. Laminate bending stiffnesses, Equation (5.3.6), are calculated from

$${D}_{ijkl} = \frac{1}{3} {\sum }_{m = 1}^{N} {\overline{Q}}_{ijkl}^{m} ( {( {z}^{m} )}^{3} - {( {z}^{m - 1} )}^{3} ) \qquad ( 8.4 .1 )$$

The specified components Dᵢⱼₖₗ^{spec} are given in below in a column format although it is understood that this is a fourth-order tensor property. Notice that, in contrast to previous examples, the absolute bending stiffness of the plate rather than the specific stiffness is being designed. This reduces by one the number of design equations available.

$${D}_{ijkl}^{spec} = \{ \begin{matrix}{D}_{1111}^{spec} \\ {D}_{1112}^{spec} \\ {D}_{1122}^{spec} \\ {D}_{1212}^{spec} \\ {D}_{1222}^{spec} \\ {D}_{2222}^{spec}\end{matrix} \} \qquad ( 8.4 .2 )$$

There are two linear invariants of fourth order tensors given the symmetry properties of elastic bending stiffnesses.
Dᵢⱼᵢⱼ^{spec}=D₁₁₁₁^{spec}+2D₁₂₁₂^{spec}+D₂₂₂₂^{spec}
Dᵢⱼᵢⱼ^{spec}=D₁₁₁₁^{spec}+2D₁₁₂₂^{spec}+D₂₂₂₂^{spec} (8.4.3)

Similarly, the linear invariants of the candidate laminate are

$${D}_{ijij}^{lam} = {D}_{1111}^{lam} + 2 {D}_{1212}^{lam} + {D}_{2222}^{lam} = \frac{1}{3} {\sum }_{m = 1}^{N} ( {Q}_{1111}^{m} + 2 {Q}_{1212}^{m} + {Q}_{2222}^{m} ) ( {( {z}^{m} )}^{3} - {( {z}^{m - 1} )}^{3} ) \\ {D}_{iijj}^{lam} = {D}_{1111}^{lam} + 2 {D}_{1122}^{lam} + {D}_{2222}^{lam} = \frac{1}{3} {\sum }_{m = 1}^{N} ( {Q}_{1111}^{m} + 2 {Q}_{1122}^{m} + {Q}_{2222}^{m} ) ( {( {z}^{m} )}^{3} - {( {z}^{m - 1} )}^{3} ) \qquad ( 8.4 .4 )$$

Setting the invariants of the specified requirements equal to the invariants of the laminate creates two cubic equations, which can be solved for the required ply coordinates z^{m}.
Dᵢⱼᵢⱼ^{spec}=Dᵢⱼᵢⱼ^{lam}
Dᵢᵢⱼⱼ^{spec}=Dᵢᵢⱼⱼ^{lam} (8.4.5)

Notice that if N is the number of plies of a single material, these equations are either true or false and of limited use. However, if N is identified as the number of materials used in creating a laminate, then we have equations useful for the design of new materials. For the case N=2 equations (8.4.5) can be solved exactly for the required ply coordinates of each material. To be a feasible solution, the ply coordinates must all be ordered such that positive material thicknesses t^{m} are obtained. That is,
z^{m}>z^{m-1}
t^{m}=z^{m}−z^{m-1} (8.4.6)

A solution where this ordering is not maintained is not a feasible solution. The thickness of the overall laminate h and the thickness fraction v^{m} relations, although not adding in this case to the number of equations, are

$$h = {z}^{N} - {z}^{0} \\ {v}^{m} = \frac{{t}^{m}}{h} = \frac{{z}^{m} - {z}^{m - 1}}{{z}^{N} - {z}^{0}} \qquad ( 8.4 .7 )$$

Without any loss of generality, setting the first coordinate z⁰, which is arbitrary, equal to the negative of the last coordinate z^{N} simply ensures that the bending stiffness will be calculated relative to the laminate midplane as is customary.
z⁰=−z^{N} (8.4.8)

Note that these laminates are generally not symmetric, although that can easily be achieved through judicious choice of coordinates and bending definitions.

Layup angles are again found once a feasible design has been established. The best overall laminate will be the one that minimizes the tensor norm invariant of the difference between the specified tensor and the candidate laminate. Layup angles can be found by minimizing:

$$min \frac{( {D}_{ijkl}^{spec} - {D}_{ijkl}^{lam} ) ( {D}_{ijkl}^{spec} - {D}_{ijkl}^{lam} )}{{D}_{ijkl}^{spec} {D}_{ijkl}^{spec}} \qquad ( 8.4 .9 )$$

Dividing by the norm of the goal serves to nondimensionalize the problem so that different cases can be compared.

Numerical Example

The objective is to design a laminate with the following specified stiffnesses:

$$\{ \begin{matrix}{D}_{1111}^{spec} = 7.0 \\ {D}_{1112}^{spec} = 0 \\ {D}_{1122}^{spec} = 0.2 \\ {D}_{1212}^{spec} = 0.4 \\ {D}_{1222}^{spec} = 0 \\ {D}_{2222}^{spec} = 1.0\end{matrix} \} kN - m \qquad ( 8.4 .10 )$$

Consider that two candidate materials with the following properties exist:

$$\begin{matrix}T300 \\ \{ \begin{matrix}{Q}_{1111}^{1} = 181.8 \\ {Q}_{1112}^{1} = 0 \\ {Q}_{1122}^{1} = 2.90 \\ {Q}_{1212}^{1} = 7.17 \\ {Q}_{1222}^{1} = 0 \\ {Q}_{2222}^{1} = 10.35\end{matrix} \} GPa\end{matrix} \begin{matrix}E \text{-} glass \\ \{ \begin{matrix}{Q}_{1111}^{2} = 39.2 \\ {Q}_{1112}^{2} = 0 \\ {Q}_{1122}^{2} = 2.18 \\ {Q}_{1212}^{2} = 4.14 \\ {Q}_{1222}^{2} = 0 \\ {Q}_{2222}^{2} = 8.39\end{matrix} \} GPa\end{matrix} \qquad ( 8.4 .11 )$$

Setting the two first invariants of the specification equal to the first invariants of the laminate yields
8400=4.8710¹⁰(z¹)³+8.3310¹⁰(z²)
8800=5.0210¹⁰(z¹)³+8.7510¹⁰(z²)³ (8.4.12)

Together with the arbitrary assignment of one coordinate (8.4.8), equations (8.4.12) can be solved explicitly for the required coordinates for a feasible solution.
z⁰=−0.00455 m z¹=0.00277 m z²=0.00455 m (8.4.13)

These coordinates imply that the respective thicknesses of the two layers are
t¹=0.00732 m t²=0.00178 m (8.4.14)

The coordinates are used to reduce the tensor norm invariant of the difference between the specified laminate and the candidate laminate, Equation (8.3.6), to a function of the two layup angles (θ¹, θ²). A robust global optimization [22] of the function yields a solution
(θ¹=−1.9°, θ²=37.4°) (8.4.15)
which leads to this result for the final laminate:

$$\{ \begin{matrix}{D}_{1111}^{lam} = 7.1 \\ {D}_{1112}^{lam} = 0 \\ {D}_{1122}^{lam} = 0.3 \\ {D}_{1212}^{lam} = 0.5 \\ {D}_{1222}^{lam} = 0 \\ {D}_{2222}^{lam} = 0.7\end{matrix} \} kN - m \qquad ( 8.4 .16 )$$

Laminate Specific Bending Stiffness
Design Objective

The specific (or normalized) bending stiffness \hat{D}ᵢⱼₖₗ^{lam} is a fourth order tensor property of a laminate. The objective is to design a laminate with specified properties from a catalog of candidate materials. Laminate specific bending stiffnesses, Equation (5.3.7), are calculated from

$${\hat{D}}_{ijkl} = \frac{1}{3 {h}^{3}} {\sum }_{m = 1}^{N} {\overline{Q}}_{ijkl}^{m} ( {( {z}^{m} )}^{3} - {( {z}^{m - 1} )}^{3} ) \qquad ( 8.5 .1 )$$

where the thickness h is calculated from the through thickness coordinates as
h=z^{N}−z⁰ (8.5.2)

Without any loss of generality the first coordinate z⁰, which is arbitrary, may be set equal to the negative of the last coordinate z^{N}. This simply ensures that the bending stiffness will be calculated relative to the laminate midplane as is customary.
z⁰=−z^{N} (8.5.3)

The specific bending stiffness in Equation (8.5.1) may then be written

$${\hat{D}}_{ijkl} = \frac{1}{3 {x2}^{3}} {\sum }_{m = 1}^{N} {\overline{Q}}_{ijkl}^{m} ( {( \frac{{z}^{m}}{{z}^{N}} )}^{3} - {( \frac{{z}^{m - 1}}{{z}^{N}} )}^{3} ) \qquad ( 8.5 .4 )$$

where

$$\frac{{z}^{m}}{{z}^{N}}$$

takes the role of a new variable, the normalized or fractional coordinate.

The specified components \hat{D}ᵢⱼₖₗ^{spec} are given in below in a colurn format although it is understood that this is a fourth-order tensor property.

$${\hat{D}}_{ijkl}^{spec} = \{ \begin{matrix}{\hat{D}}_{1111}^{spec} \\ {\hat{D}}_{1112}^{spec} \\ {\hat{D}}_{1122}^{spec} \\ {\hat{D}}_{1212}^{spec} \\ {\hat{D}}_{1222}^{spec} \\ {\hat{D}}_{2222}^{spec}\end{matrix} \} \qquad ( 8.5 .5 )$$

There are two linear invariants of fourth order tensors given the symmetry properties of elastic bending stiffnesses.
\hat{D}ᵢⱼᵢⱼ^{spec}=\hat{D}₁₁₁₁^{spec}+2\hat{D}₁₂₁₂^{spec}+\hat{D}₂₂₂₂^{spec}
\hat{D}ᵢᵢⱼⱼ^{spec}=\hat{D}₁₁₁₁^{spec}+2\hat{D}₁₁₂₂^{spec}+\hat{D}₂₂₂₂^{spec} (8.5.6)

Similarly, the linear invariants of the candidate laminate are

$${\hat{D}}_{ijij}^{lam} = {\hat{D}}_{1111}^{lam} + 2 {\hat{D}}_{1212}^{lam} + {\hat{D}}_{2222}^{lam} = \frac{1}{3 {x2}^{3}} {\sum }_{m = 1}^{N} ( {Q}_{1111}^{m} + 2 {Q}_{1212}^{m} + {Q}_{2222}^{m} ) ( {( \frac{{z}^{m}}{{z}^{N}} )}^{3} - {( \frac{{z}^{m - 1}}{{z}^{N}} )}^{3} ) \\ {\hat{D}}_{iijj}^{lam} = {\hat{D}}_{1111}^{lam} + 2 {\hat{D}}_{1122}^{lam} + {\hat{D}}_{2222}^{lam} = \frac{1}{3 {x2}^{3}} {\sum }_{m = 1}^{N} ( {Q}_{1111}^{m} + 2 {Q}_{1122}^{m} + {Q}_{2222}^{m} ) ( {( \frac{{z}^{m}}{{z}^{N}} )}^{3} - {( \frac{{z}^{m - 1}}{{z}^{N}} )}^{3} ) \qquad ( 8.5 .7 )$$

Setting the invariants of the specified requirements equal to the invariants of the laminate creates two cubic equations, which can be solved for the required normalized ply coordinates

$$\frac{{z}^{m}}{{z}^{N}} .$$

\hat{D}ᵢⱼᵢⱼ^{spec}=\hat{D}ᵢⱼᵢⱼ^{lam}
\hat{D}ᵢᵢⱼⱼ^{spec}=\hat{D}ᵢᵢⱼⱼ^{lam}

Notice that if N is the number of plies of a single material, these equations are either true or false and of limited use. However, if N is identified as the number of materials used in creating a laminate, then we have equations useful for the design of new materials. For the case N=3 equations (8.5.8) can be solved exactly for the required normalized ply coordinates of each material. To be a feasible solution, the normalized ply coordinates must all be ordered such that positive material thicknesses t^{m} are obtained, which is also the equivalent of ensuring that the thickness fractions v^{m} are positive and between zero and one. That is,

$$- 1 \leq \frac{{z}^{m - 1}}{{z}^{N}} < \frac{{z}^{m}}{{z}^{N}} \leq 1 \\ {v}^{m} = \frac{{t}^{m}}{h} = \frac{{z}^{m} - {z}^{m - 1}}{{z}^{N} - {z}^{0}} = \frac{{z}^{m} - {z}^{m - 1}}{2 {z}^{N}} \\ {\sum }_{m = 1}^{N} {v}^{m} = 1 \qquad ( 8.5 .9 )$$

Note that these laminates are generally not symmetric, although that can easily be achieved through judicious choice of coordinates and bending definitions.

Layup angles are again found once a feasible design has been established. The best overall laminate will be the one that minimizes the tensor norm invariant of the difference between the specified tensor and the candidate laminate. Layup angles can be found by minimizing:

$$min \frac{( {D}_{ijkl}^{spec} - {D}_{ijkl}^{lam} ) ( {D}_{ijkl}^{spec} - {D}_{ijkl}^{lam} )}{{D}_{ijkl}^{spec} {D}_{ijkl}^{spec}} \qquad ( 8.5 .10 )$$

Dividing by the norm of the goal serves to nondimensionalize the problem so that different cases can be compared.

Numerical Example

The objective is to design a laminate with the following specified stiffnesses:

$$\{ \begin{matrix}{D}_{1111}^{spec} = 8.27 \\ {D}_{1112}^{spec} = 0 \\ {D}_{1122}^{spec} = 0.19 \\ {D}_{1212}^{spec} = 0.38 \\ {D}_{1222}^{spec} = 0 \\ {D}_{2222}^{spec} = 0.67\end{matrix} \} GPa \qquad ( 8.5 .11 )$$

Consider that three candidate materials with the following properties exist:

$$\begin{matrix}T300 \\ \{ \begin{matrix}{Q}_{1111}^{1} = 181.8 \\ {Q}_{1112}^{1} = 0 \\ {Q}_{1122}^{1} = 2.90 \\ {Q}_{1212}^{1} = 7.17 \\ {Q}_{1222}^{1} = 0 \\ {Q}_{2222}^{1} = 10.35\end{matrix} \} QPa\end{matrix} \begin{matrix}E \text{-} glass \\ \{ \begin{matrix}{Q}_{1111}^{2} = 39.2 \\ {Q}_{1112}^{2} = 0 \\ {Q}_{1122}^{2} = 2.18 \\ {Q}_{1212}^{2} = 4.14 \\ {Q}_{1222}^{2} = 0 \\ {Q}_{2222}^{2} = 8.39\end{matrix} \} GPa\end{matrix} \begin{matrix}Kevlar \text{-} 49 \\ \{ \begin{matrix}{Q}_{1111}^{3} = 76.6 \\ {Q}_{1112}^{3} = 0 \\ {Q}_{1122}^{3} = 1.89 \\ {Q}_{1212}^{3} = 2.30 \\ {Q}_{1222}^{3} = 0 \\ {Q}_{2222}^{3} = 5.55\end{matrix} \}\end{matrix} GPa \qquad ( 8.5 .12 )$$

Setting the two first invariants of the specification equal to the first invariants of the laminate yields

$$0.411 + {( \frac{{z}^{1}}{{z}^{3}} )}^{3} - 0.233 {( \frac{{z}^{2}}{{z}^{3}} )}^{3} = 0 \\ 0.402 + {( \frac{{z}^{1}}{{z}^{3}} )}^{3} - 0.2050 {( \frac{{z}^{2}}{{z}^{3}} )}^{3} = 0 \qquad ( 8.5 .13 )$$

Equations (8.5.13) can be solved explicitly for the required normalized coordinates for a feasible solution.

$$\frac{{z}^{1}}{{z}^{3}} = - 0.693 \frac{{z}^{2}}{{z}^{3}} = 0.693 \qquad ( 8.5 .14 )$$

These coordinates imply that the respective volume fractions of the three layers are
v¹=0.153 v²=0.693 v³=0.153 (8.5.15)

The normalized coordinates are used to reduce the tensor norm invariant of the difference between the specified laminate and the candidate laminate, Equation (8.5.10), to a function of the three layup angles (θ¹, θ², θ³). A robust global optimization [22] of the function yields a solution
(θ¹=0°, θ²=0°, θ³=0°) (8.5.16)
which leads to this result for the final laminate:

$$\{ \begin{matrix}{D}_{1111}^{spec} = 8.27 \\ {D}_{1112}^{spec} = 0 \\ {D}_{1122}^{spec} = 0.19 \\ {D}_{1212}^{spec} = 0.38 \\ {D}_{1222}^{spec} = 0 \\ {D}_{2222}^{spec} = 0.67\end{matrix} \} GPa \qquad ( 8.5 .17 )$$

Interestingly, changing the stacking sequence or ordering of the materials gives the same numerical values for the volume fractions, albeit associated with different materials as shown below in Table 4.

TABLE 4
Stacking Sequence Effect on Specific Bending Stiffness

| | | Stacking | Stacking | Stacking |
|---|---|---|---|---|
| Material | Volume | Sequence | Sequence | Sequence |
| Number | Fraction | 1 | 2 | 3 |
| 1 | 0.153 | T300 | E-Glass | E-Glass |
| 2 | 0.693 | E-Glass | T300 | Keviar 49 |
| 3 | 0.153 | Kevlar 49 | Kevlar 49 | T300 |

Laminate Coupling Stiffness
Design Objective

The coupling stiffness Bᵢⱼₖₗ^{lam} is a fourth order tensor property of a laminate. The objective is to design a laminate with specified properties from a catalog of candidate materials. Laminate coupling stiffnesses, Equation (5.3.6), are calculated from

$${B}_{ijkl} = \frac{1}{2} {\sum }_{m = 1}^{N} {\overline{Q}}_{ijkl}^{m} ( {( {z}^{m} )}^{2} - {( {z}^{m - 1} )}^{2} ) \qquad ( 8.6 .1 )$$

The specified components Bᵢⱼₖₗ^{spec} are given in below in a column format although it is understood that this is a fourth-order tensor property. Notice that, in contrast to previous examples, the absolute coupling stiffness of the plate rather than the specific stiffness is being designed. This reduces by one the number of design equations available.

$${B}_{ijkl}^{spec} = \{ \begin{matrix}{B}_{1111}^{spec} \\ {B}_{1112}^{spec} \\ {B}_{1122}^{spec} \\ {B}_{1212}^{spec} \\ {B}_{1222}^{spec} \\ {B}_{2222}^{spec}\end{matrix} \} \qquad ( 8.6 .2 )$$

There are two linear invariants of fourth order tensors given the symmetry properties of elastic coupling stiffnesses.
Bᵢⱼᵢⱼ^{spec}=B₁₁₁₁^{spec}+2B₁₂₁₂^{spec}+B₂₂₂₂^{spec}
Bᵢᵢⱼⱼ^{spec}=B₁₁₁₁^{spec}+2B₁₁₂₂^{spec}+B₂₂₂₂^{spec} (8.6.3)

Similarly, the linear invariants of the candidate laminate are

$${B}_{ijij}^{lam} = {B}_{1111}^{lam} + 2 {B}_{1212}^{lam} + {B}_{2222}^{lam} = \frac{1}{2} {\sum }_{m = 1}^{N} ( {Q}_{1111}^{m} + 2 {Q}_{1212}^{m} + {Q}_{2222}^{m} ) ( {( {z}^{m} )}^{2} - {( {z}^{m - 1} )}^{2} ) \\ {B}_{iijj}^{lam} = {B}_{1111}^{lam} + 2 {B}_{1122}^{lam} + {B}_{2222}^{lam} = \frac{1}{3} {\sum }_{m = 1}^{N} ( {Q}_{1111}^{m} + 2 {Q}_{1122}^{m} + {Q}_{2222}^{m} ) ( {( {z}^{m} )}^{2} - {( {z}^{m - 1} )}^{2} ) \qquad ( 8.6 .4 )$$

Setting the invariants of the specified requirements equal to the invariants of the laminate creates two quadratic equations, which can be solved for the required ply coordinates z^{m}.
Bᵢⱼᵢⱼ^{spec}=Bᵢⱼᵢⱼ^{lam}
Bᵢᵢⱼⱼ^{spec}=Bᵢᵢⱼⱼ^{lam} (8.6.5)

Notice that if N is the number of plies of a single material, these equations are either true or false and of limited use. However, if N is identified as the number of materials used in creating a laminate, then we have equations useful for the design of new materials. For the case N=2 equations (8.6.5) can be solved exactly for the required ply coordinates of each material. To be a feasible solution, the ply coordinates must all be ordered such that positive material thicknesses t^{m} are obtained. That is,
z^{m}>z^{m-1}
t^{m}=z^{m}−z^{m-1} (8.6.6)

A solution where this ordering is not maintained is not a feasible solution. The thickness of the overall laminate h and the thickness fraction v^{m} relations, although not adding in this case to the number of equations, are

$$\begin{matrix}h = {z}^{N} - {z}^{0} \\ {v}^{m} = \frac{{t}^{m}}{h} = \frac{{z}^{m} - {z}^{m - 1}}{{z}^{N} - {z}^{0}}\end{matrix} \qquad ( 8.6 .7 )$$

Without any loss of generality, setting the first coordinate z⁰, which is arbitrary, equal to the negative of the last coordinate z^{N} simply ensures that the bending stiffness will be calculated relative to the laminate midplane as is customary.
z⁰=−z^{N} (8.6.8)

Note that these laminates are generally not symmetric, although that can easily be achieved through judicious choice of coordinates and bending definitions.

Layup angles are again found once a feasible design has been established. The best overall laminate will be the one that minimizes the tensor norm invariant of the difference between the specified tensor and the candidate laminate. Layup angles can be found by minimizing:

$$min \frac{( {B}_{ijkl}^{spec} - {B}_{ijkl}^{spec} ) ( {B}_{ijkl}^{spec} - {B}_{ijkl}^{lam} )}{{B}_{ijkl}^{spec} {B}_{ijkl}^{spec}} \qquad ( 8.6 .9 )$$

Dividing by the norm of the goal serves to nondimensionalize the problem so that different cases can be compared.

Sandwich Bending Stiffness

Design Objective

Consider the bending stiffness of a sandwich panel with thin facesheets:

$${D}_{ijkl}^{sand} ≅ \frac{{h}^{2}}{4} {A}_{ijkl} = \frac{{h}^{2}}{4} {\sum }_{m = 1}^{N} {\overline{Q}}_{ijkl}^{m} {t}^{m} i , j , k , l = 1 , 2 \qquad ( 8.7 .1 )$$

where h is the total thickness of the panel. The bending stiffnesses represent a structural rather than material quantity. The objective is to design the sandwich bending stiffness tensor Dᵢⱼₖₗ^{sand}. The concept of an intrinsic bending stiffness is not completely clear. However, fixing the overall desired thickness of the panel effectively accomplishes the same thing. Therefore, this example varies slightly from the previous ones in that the actual thickness of layers of material in the sandwich facesheets are found rather than the thickness fractions. The principle of design is the same. There are two linear invariants of the bending stiffness:

$$\begin{matrix}\begin{matrix}{D}_{ijij}^{sand} = \frac{{h}^{2}}{4} {\sum }_{m = 1}^{N} ( {Q}_{1111}^{m} + 2 {Q}_{1212}^{m} + {Q}_{2222}^{m} ) {t}^{m} \\ {D}_{iijj}^{sand} = \frac{{h}^{2}}{4} {\sum }_{m = 1}^{N} ( {Q}_{1111}^{m} + 2 {Q}_{1122}^{m} + {Q}_{2222}^{m} ) {t}^{m}\end{matrix} \\ h = {h}^{c} + {\sum }_{m = 1}^{N} {t}^{m}\end{matrix} \qquad ( 8.7 .2 )$$

Setting the invariants of the goal values equal to the invariants of the sandwich creates two cubic equations in ply and core thickness plus the overall thickness requirement:

$$\begin{matrix}\begin{matrix}{D}_{ijij}^{spec} = {D}_{ijij}^{sand} \\ {D}_{iijj}^{spec} = {D}_{iijj}^{sand}\end{matrix} \\ {h}^{spec} = {h}^{c} + {\sum }_{m = 1}^{N} {t}^{m}\end{matrix} \qquad ( 8.7 .3 )$$

Note that the use of invariants separates the cubic thickness terms from the stiffnesses. For the case N=2 these equations can be solved exactly for the required thicknesses. The feasibility of a sandwich panel bending stiffness design is thus established for any two material constituents if the thicknesses are positive and satisfy the assumption of thinness. Again, if a catalog of materials is available (as in many finite element codes), feasible sandwich designs may be found.

Layup angles are found in a second step by minimizing the tensor norm of the difference between the specified sandwich and the candidate sandwich structure.

$$min \frac{( {D}_{ijkl}^{spec} - {D}_{ijkl}^{sand} ) ( {D}_{ijkl}^{spec} - {D}_{ijkl}^{sand} )}{{D}_{ijkl}^{spec} {D}_{ijkl}^{spec}} \qquad ( 8.7 .4 )$$

Numerical Example Consider that a catalog of the same three materials is available as for the laminate stiffness example, Equation (8.3.8), although the objective is to find the best two materials that satisfy the specified requirements. In principle, the catalog could be quite large since the feasibility problem is linear. An example objective is to design a sandwich from these three materials with the following goal bending stiffnesses:

$$\{ \begin{matrix}{D}_{1111}^{spec} = 20 \\ {D}_{1112}^{spec} = 0 \\ {D}_{1122}^{spec} = 0.5 \\ {D}_{1212}^{spec} = 1 \\ {D}_{1222}^{spec} = 0 \\ {D}_{2222}^{spec} = 10\end{matrix} \} kNm \qquad ( 8.7 .5 )$$

The sandwich will be required to be 2 cm thick. Solving the thickness equations for each two-material combination of the three available catalog materials yields three possible solutions:
(T300, E-glass): h^{c}=1.99 cm t¹=0.21 cm t²=−0.20 cm
(T300, Kevlar): h^{c}=1.78 cm t¹=0.10 cm t²=0.12 cm (8.7.6)
(E-glass, Kevlar): h^{c}=1.56 cm t¹=0.24 cm t²=0.20 cm

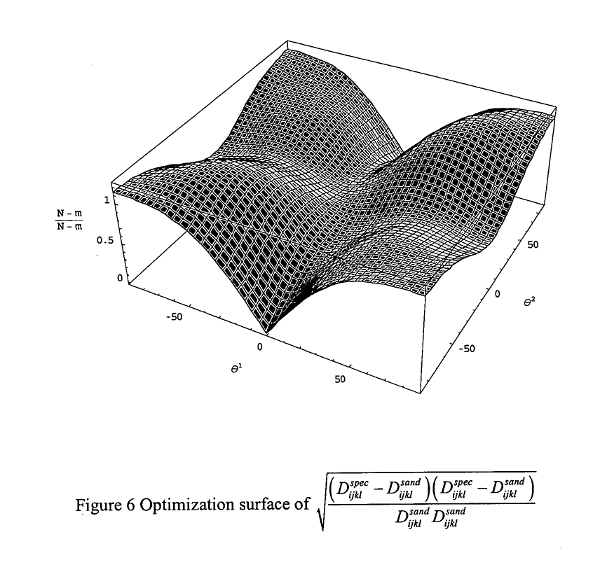

The first design is not feasible (one thickness less than zero), while the second and third are. The second combination more closely satisfies the theory requirement that the facesheets be thin. The layup angles are then found by minimizing the nonlinear tensor norm invariant of the difference between the goal and the laminate. A robust global optimization of the function for the material thicknesses of Case 2 yields (θ¹=0°, θ²=90°). FIG. 6 shows the complete optimization surface as a function of the two layup angles. The figure is plotting the “length” of the difference between the goal and the laminate divided by the goal. The feasible solution thicknesses from the second solution in Equation (8.7.6) have already been incorporated. The optimum layup angles occur when the function approaches zero, that is, no difference between goal and laminate. Conversely, notice that there are regions of the plot where the current laminate is as far from the goal as the goal itself (values of one or greater).

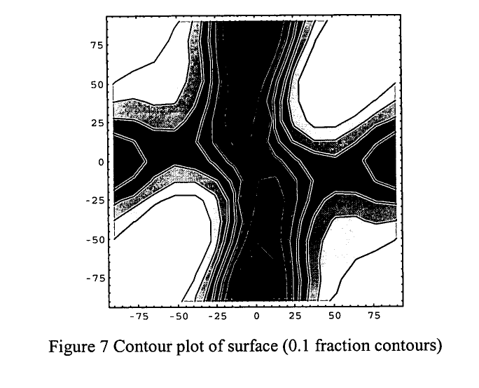

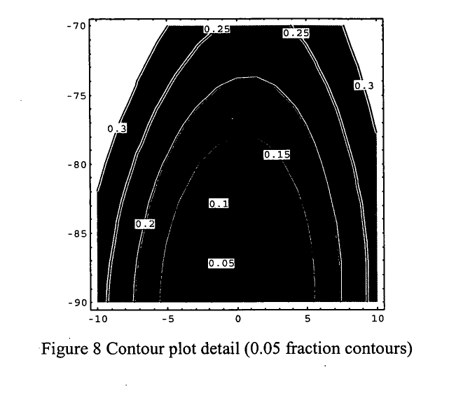

FIGS. 7 and 8 are contour plots of the region near the optimum solution, illustrating the robustness of the solution. Although the function changes rapidly, small changes in layup angles, on the order of a couple of degrees, have only a small effect. From a manufacturing standpoint, it is important to know how tight the tolerances on layup angles must be to achieve the designed laminate. In this case, the desired laminate is easily manufactured.

From a design standpoint, it is probably best to establish a standard of “goodness” a priori. For example, a laminate within 5% of the goal by the definitions given here could be considered sufficient. The plots in FIGS. 7 and 8 then show regions within which the design goal has been met.

The result for the final sandwich, which is within 0.6% of the goal, is:

$$\{ \begin{matrix}{D}_{1111}^{sand} = 19.9 \\ {D}_{1112}^{sand} = 0 \\ {D}_{1122}^{sand} = 0.5 \\ {D}_{1212}^{sand} = 1.0 \\ {D}_{1222}^{sand} = 0 \\ {D}_{2222}^{sand} = 10.0\end{matrix} \} kNm \qquad ( 8.7 .7 )$$

In-Plane Thermal Expansion
Design Objective

The objective is to design the in-plane thermal expansion of a laminate \hat{α}ᵢⱼ^{spec}, a second order intrinsic (as indicated by the hat over the symbol) tensor material property that is specified by

$${\hat{α}}_{ij}^{spec} = ( \begin{matrix}{\hat{α}}_{11}^{spec} & {\hat{α}}_{12}^{spec} \\ {\hat{α}}_{12}^{spec} & {\hat{α}}_{22}^{spec}\end{matrix} ) \qquad ( 8.8 .1 )$$

The in-plane thermal expansion of a laminate can be calculated from the plane stress reduced stiffnesses Qᵢⱼₖₗ^{m}, ply thicknesses t^{m}, and thermal expansion properties αᵢⱼ^{m} of each ply by

$$\begin{matrix}{\hat{α}}_{ij}^{lam} = {a}_{ijkl} {\sum }_{m = 1}^{N} {\overline{Q}}_{klpq}^{m} {t}^{m} {\overline{α}}_{pq}^{m} \\ {a}_{ijkl} {\sum }_{m = 1}^{N} {\overline{Q}}_{klpq}^{m} {t}^{m} = \frac{1}{2} ( {δ}_{ip} {δ}_{jq} + {δ}_{iq} {δ}_{jp} )\end{matrix} i , j , k , l , p , q = 1 , 2 \qquad ( 8.8 .2 )$$

where aᵢⱼₖₗ is the inverse of

$${\sum }_{m = 1}^{N} {\overline{Q}}_{klpq}^{m} {t}^{m} ,$$

defined by the second of equations (8.8.2) and δᵢⱼ is the m=1 Kronecker delta. Thus, the design of laminates for specific thermal expansion properties is difficult because two material properties—thermal expansion and elastic stiffness—are involved as well as the inverse of the stiffness tensor. An explicit expression for the thermal expansion properties of a laminate in two dimensions [23] is given by

$${\hat{α}}_{ij}^{lam} = \frac{6 \{ {A}_{ijmn} {A}_{mnkl} - {A}_{uvuv} {A}_{ijkl} + \frac{1}{2} ( {A}_{uvuv} {A}_{rsrs} - {A}_{uvrs} {A}_{rsuv} ) \frac{1}{2} ( {δ}_{ik} {δ}_{jl} + {δ}_{il} {δ}_{jk} ) \} {\sum }_{m = 1}^{N} {\overline{Q}}_{klpq}^{m} {t}^{m} {\overline{α}}_{pq}^{m}}{( {A}_{uvuv} {A}_{rsrs} {A}_{pqpq} - 3 {A}_{uvrs} {A}_{rsuv} {A}_{pqpq} + 2 {A}_{uvrs} {A}_{rspq} {A}_{pquv} )} \qquad ( 8.83 )$$

where the Aᵢⱼₖₗ are the laminate stiffnesses defined in Equation (5.3.6). There is one linear invariant of the in-plane thermal expansion
\hat{α}ᵢᵢ=\hat{α}₁₁+\hat{α}₂₂ (8.8.4)

However, two important features distinguish this example from the previous ones. One, the separation of thickness fractions (thicknesses) and layup angles that occurred with previous design examples though the use of the linear invariant Equation (8.8.4) does not happen. The inversion of the stiffness matrix and convolution of two material properties as shown in Equation (8.8.3) prevent this separation. Two, while most material properties tend have only positive values, thermal expansion values can be both positive and negative. As a consequence, setting the invariants of the specified requirements equal to the invariants of the laminate, together with the requirement that thickness fractions be positive and sum to one, does not create two linear equations.

$$\begin{matrix}{\hat{α}}_{ii}^{spec} = {\hat{α}}_{ii}^{lam} \\ {\sum }_{m = 1}^{N} {v}^{m} = 1 {v}^{m} = \frac{{t}^{m}}{h}\end{matrix} \qquad ( 8.8 .5 )$$

Nevertheless, the fact that two equations are available supports the conjecture that, if the number of materials N=2, a feasible solution can be found.

Layup angles and thickness fractions are found simultaneously by minimizing the tensor norm invariant of the difference between the specified tensor and the candidate laminate.

$$min \frac{( {\hat{α}}_{ij}^{spec} - {\hat{α}}_{ij}^{lam} ) ( {\hat{α}}_{ij}^{spec} - {\hat{α}}_{ij}^{lam} )}{{\hat{α}}_{ij}^{spec} {\hat{α}}_{ij}^{spec}} \qquad ( 8.8 .6 )$$

Layup Angles and Thickness Fractions within Materials

In-plane thermal expansion design laminates may be considered to be symmetric about the midplane. In general, this needn't be the case, but a thermal curvature design problem would then be added. For design problems in which the number of materials equals the number of plies, four variables are used in the minimization problem of Equation (8.8.6): two layup angles and two thickness fractions.
{(θ₁¹,v₁¹/2)/(θ₂²,v₂²/2)}_{sym}
(θ_{ply}^{mat},v_{ply}^{mat}/2)=(angle, thickness fraction) (8.8.7)

Nevertheless, it is certainly possible to use more plies and layup angles than just one set per material. It is therefore reasonable to ask how many plies/layup angles combinations are necessary per material. Quasi-isotropic laminates exhibit a limiting case of laminate material behavior. Therefore, the following conjecture is proposed:

The maximum necessary number of plies and layup angles per unique material in a laminate is equal to the minimum number of layup angles required to construct a quasi-isotropic material from equal thickness plies.
The maximum necessary number of plies and layup angles per unique material in a laminate is equal to the minimum number of layup angles required to construct a quasi-isotropic material from equal thickness plies. (8.8.8)

For second order tensors such as thermal expansion, quasi-isotropic laminates can be constructed using (0/90)_{sym} laminates. Hence, the conjecture implies that only two plies/angles per material in a multiple material laminate are the maximum necessary. Similarly, for fourth order tensors such as stiffness, quasi-isotropic laminates can be constructed using (0/60/−60)_{sym} laminates.

Hence, the conjecture implies that only three plies/angles per material in a multiple material laminate are the maximum necessary.

In summary, for thermal expansion design problems (second order tensors), Equations (8.8.5) suggest that N=2 materials will enable a feasible design and the conjecture (8.8.8) states that two plies/angles per material are the maximum necessary. That is, the most general thermal expansion laminate is
{(θ₁¹,v₁¹/2)/(θ₂¹,v₂¹/2)/(θ₁²,v₁²/2)/(θ₂²,v₂²/2)} (8.8.9)

The numerical examples illustrate these concepts.

Numerical Example: Two Materials, One Angle/One Thickness Fraction Each

The objective is to design a laminate with the following specified thermal expansion properties:

$${α}_{ij}^{spec} = \{ \begin{matrix}3.0 & 0 \\ 0 & 1.0\end{matrix} \} ppm \text{/} K \qquad ( 8.8 .10 )$$

Two materials are to be used, but each material will consist of one ply with one associated layup angle. Consider that two candidate materials with the following properties exist:

$$\begin{matrix}K13D2U & T300 \\ \{ \begin{matrix} {Q}_{1111}^{1} = 80.1 Msi \\ {Q}_{1112}^{1} = 0 \\ {Q}_{1122}^{1} = 0.27 Msi \\ {Q}_{1212}^{1} = 0.60 Msi \\ {Q}_{1222}^{1} = 0 \\ {Q}_{2222}^{1} = 0.83 Msi \\ {α}_{11}^{1} = - 1.3 ppm \text{/} K \\ {α}_{22}^{1} = 32.0 ppm \text{/} K\end{matrix} \} & \{ \begin{matrix} {Q}_{1111}^{2} = 19.6 Msi \\ {Q}_{1112}^{2} = 0 \\ {Q}_{1122}^{2} = 0.36 Msi \\ {Q}_{1212}^{2} = 0.60 Msi \\ {Q}_{1222}^{2} = 0 \\ {Q}_{2222}^{2} = 1.21 Msi \\ {α}_{11}^{1} = 0.3 ppm \text{/} K \\ {α}_{22}^{1} = 32.5 ppm \text{/} K\end{matrix} \}\end{matrix} \qquad ( 8.8 .11 )$$

A robust global optimization [22] of the function Equation (8.8.6) for a solution with two materials, each with one ply and one angle yields a solution
{(90°, 0.57/2)/(0°, 043/2)}_{sym} (8.8.12)
which leads to this result for the final thermal expansion of the laminate:

$${α}_{ij}^{spec} = \{ \begin{matrix}2.56 & 0 \\ 0 & - 0.83\end{matrix} \} ppm \text{/} K \qquad ( 8.8 .13 )$$

This result is close, but not exact.

Numerical Example: Two Materials, Two Angles/Two Thickness Fractions Each

The objective is to design a laminate with the following specified thermal expansion properties:

$${α}_{ij}^{spec} = \{ \begin{matrix}3.0 & 0 \\ 0 & 1.0\end{matrix} \} ppm \text{/} K \qquad ( 8.8 .14 )$$

Two materials are to be used, with each material used in two plies with two associated layup angles. Consider that two candidate materials with the following properties exist:

$$\begin{matrix}K13D2U & T300 \\ \{ \begin{matrix} {Q}_{1111}^{1} = 80.1 Msi \\ {Q}_{1112}^{1} = 0 \\ {Q}_{1122}^{1} = 0.27 Msi \\ {Q}_{1212}^{1} = 0.60 Msi \\ {Q}_{1222}^{1} = 0 \\ {Q}_{2222}^{1} = 0.83 Msi \\ {α}_{11}^{1} = - 1.3 ppm \text{/} K \\ {α}_{22}^{1} = 32.0 ppm \text{/} K\end{matrix} \} & \{ \begin{matrix} {Q}_{1111}^{2} = 19.6 Msi \\ {Q}_{1112}^{2} = 0 \\ {Q}_{1122}^{2} = 0.36 Msi \\ {Q}_{1212}^{2} = 0.60 Msi \\ {Q}_{1222}^{2} = 0 \\ {Q}_{2222}^{2} = 1.21 Msi \\ {α}_{11}^{1} = 0.3 ppm \text{/} K \\ {α}_{22}^{1} = 32.5 ppm \text{/} K\end{matrix} \}\end{matrix} \qquad ( 8.8 .15 )$$

A robust global optimization [22] of the function Equation (8.8.6) for a solution with two materials, each with two plies and two angles yields a solution
{(−82.5°,0.035/2)/(14.8°,0.051/2)/(3.1°,0.220/2)/(−81.2°,0.694/2)}_{sym} (8.8.16)
which leads to this result for the final thermal expansion of the laminate:

$${α}_{ij}^{spec} = \{ \begin{matrix}3.0 & 0 \\ 0 & 1.0\end{matrix} \} ppm \text{/} K \qquad ( 8.8 .17 )$$

Clearly, the additional design variables have allowed a solution indistinguishable from the specification.

Laminate Specific In-Plane Stiffness Using Multiple Angles and Thickness Fractions

In analogy to thermal expansion, the specific in-plane stiffness of laminates can be designed using more angle/ply combinations per material than just one. The example given in Equations (8.3.1) through (8.3.12) only used one angle/ply per material. However, the conjecture in (8.8.8) suggests that three angles/plies per material are the maximum necessary for fourth order tensor material properties. Furthermore, since the invariants of specific fourth order properties can be solved using three materials, the most general laminate for this case is
{(θ₁¹,v₁¹)/(θ₂¹,v₂¹)/(θ₃¹,v₃¹)/(θ₁²,v₁²)/(θ₂²,v₂²)/(θ₃²,v₃²)/(θ₁³,v₁³)/(θ₂³,v₂³)/(θ₃³,v₃³)} (8.9.1)
where symmetry of the laminate is not necessarily assumed. This example demonstrates two design approaches using these additional variables.
Design Objective

The objective is to design the specific in-plane stiffness Âᵢⱼₖₗ^{lam} of a laminate from a catalog of candidate materials. The equations are the same as in Section 8.3 above. Briefly, laminate in-plane specific stiffness, Equation (5.3.7), is calculated from

$${\hat{A}}_{ijkl}^{lam} = \frac{1}{h} {\sum }_{m = 1}^{N} {\overline{Q}}_{ijkl}^{m} ( {z}^{m} - {z}^{m - 1} ) i , jk , l = 1 , 2 \qquad ( 8.9 .2 )$$

Setting the invariants of the specified requirements equal to the invariants of the laminate creates three linear equations including the thickness fraction requirement, which can be solved for the required thickness fractions.

$$\begin{matrix}\begin{matrix}\begin{matrix}{\hat{A}}_{ijij}^{spec} = {\hat{A}}_{ijij}^{lam} \\ {\hat{A}}_{iijj}^{spec} = {\hat{A}}_{iijj}^{lam}\end{matrix} \\ {\sum }_{m = 1}^{N} {v}^{m} = 1 where \end{matrix} \\ {v}^{m} = \frac{{t}^{m}}{h}\end{matrix} \qquad ( 8.9 .3 )$$

For the case N 3 equations (8.3.5) can be solved exactly for the required thickness fractions of each material. Layup angles are found by minimizing:

$$min \frac{( {\hat{A}}_{ijkl}^{spec} - {\hat{A}}_{ijkl}^{lam} ) ( {\hat{A}}_{ijkl}^{spec} - {\hat{A}}_{ijkl}^{lam} )}{{\hat{A}}_{ijkl}^{spec} {\hat{A}}_{ijkl}^{spec}} \qquad ( 8.9 .4 )$$

Two cases will be examined for the numerical examples: One, thickness fractions of feasible candidate materials will be found using Equation (8.9.3). Using these material thickness fractions, Equation (8.9.4) will be used to find the thickness fractions of each ply within a material and the associated layup angles for all plies in the general model of Equation (8.9.1). Two, the thickness fractions and layup angles of the general model will be found using only Equation (8.9.4).

Numerical Example One

The objective is to design a laminate with the following specified stiffnesses:

$$\{ \begin{matrix}{\hat{A}}_{1111}^{spec} = 80 \\ {\hat{A}}_{1112}^{spec} = 0 \\ {\hat{A}}_{1122}^{spec} = 2 \\ {\hat{A}}_{1212}^{spec} = 4 \\ {\hat{A}}_{1222}^{spec} = 0 \\ {\hat{A}}_{2222}^{spec} = 40\end{matrix} \} GPa \qquad ( 8.9 .5 )$$

Consider that three candidate materials with the following properties exist:

$$\begin{matrix}T300 & E - glass & Kevlar - 49 \\ \{ \begin{matrix} {Q}_{1111}^{1} = 181.8 \\ {Q}_{1112}^{1} = 0 \\ {Q}_{1122}^{1} = 2.90 \\ {Q}_{1212}^{1} = 7.17 \\ {Q}_{1222}^{1} = 0 \\ {Q}_{2222}^{1} = 10.35\end{matrix} \} GPa & \{ \begin{matrix} {Q}_{1111}^{2} = 39.2 \\ {Q}_{1112}^{2} = 0 \\ {Q}_{1122}^{2} = 2.18 \\ {Q}_{1212}^{2} = 4.14 \\ {Q}_{1222}^{2} = 0 \\ {Q}_{2222}^{2} = 8.39\end{matrix} \} GPa & \{ \begin{matrix} {Q}_{1111}^{3} = 76.6 \\ {Q}_{1112}^{3} = 0 \\ {Q}_{1122}^{3} = 1.89 \\ {Q}_{1212}^{3} = 2.30 \\ {Q}_{1222}^{3} = 0 \\ {Q}_{2222}^{3} = 5.55\end{matrix} \} GPa\end{matrix} \qquad \begin{matrix} \\ ( 8.9 .6 )\end{matrix}$$

That is, the goal is to design a laminate that is twice as stiff in one direction as the other is, a feature that none of the constituent materials have. Setting the two first invariants of the goal equal to the first invariants of the laminate yields
124=195.95v¹+51.95v²+85.93v³
128=206.49v¹+55.87v²+86.75v³
1=v¹+v²+v³ (8.9.7)

Together with the volume fraction relation equations (8.3.9) can be solved explicitly for the required volume fractions for a feasible solution
v¹=0.37 V²=0.10 V³=0.53 (8.9.8)

Introducing the new thickness fractions and layup angles of Equation (8.9.1), but retaining the thickness fractions found above requires the thickness fractions of each ply associated with a single material sum to the thickness fraction of the material itself.
v₁¹+v₂¹+v₃¹=v¹
v₁²+v₂²+v₃²=v²
v₁³+v₂³+v₃³=v³ (8.9.9)

Using these constraints, a nonlinear minimization of Equation (8.9.4) leads to the following solution

$$\{ \begin{matrix}\begin{matrix}( - {29.7}^{°} , .001 ) / ( {0.6}^{°} , .220 ) / ( - {0.3}^{°} , .149 ) / \\ ( {9.8}^{°} , .038 ) / ( - {1.7}^{°} , .037 ) / ( - {65.1}^{°} , .026 ) /\end{matrix} \\ ( {36.2}^{°} , .060 ) / ( {2.9}^{°} , .039 ) / ( - {87.3}^{°} , .430 )\end{matrix} \} \qquad ( 8.9 .10 )$$

which leads to this result for the final laminate:

$$\{ \begin{matrix}{\hat{A}}_{1111}^{lam} = 77.8 \\ {\hat{A}}_{1112}^{lam} = 1.7 \\ {\hat{A}}_{1122}^{lam} = 3.5 \\ {\hat{A}}_{1212}^{lam} = 5.5 \\ {\hat{A}}_{1222}^{lam} = - 0.9 \\ {\hat{A}}_{2222}^{lam} = 39.2\end{matrix} \} GPa \qquad ( 8.9 .11 )$$

Notice that this optimization did not yield an exact match to the goal. Nonlinear design problems do not guarantee exact solutions. Furthermore, it will be appreciated that nonlinear problems can admit more than one solution, meaning that families of solutions may be available.

Numerical Example Two

The objective is the same as above, to design a laminate with the following specified stiffnesses, from the same catalog of available materials

$$\{ \begin{matrix}{\hat{A}}_{1111}^{spec} = 80 \\ {\hat{A}}_{1112}^{spec} = 0 \\ {\hat{A}}_{1122}^{spec} = 2 \\ {\hat{A}}_{1212}^{spec} = 4 \\ {\hat{A}}_{1222}^{spec} = 0 \\ {\hat{A}}_{2222}^{spec} = 40\end{matrix} \} GPa \qquad ( 8.9 .12 )$$

However, this time Equations (8.9.3) are not used to find the material thickness fractions. Instead, the only requirement on the new thickness fractions of Equation (8.9.1) other than being positive and between zero and one is that they sum to one.
v₁¹+v₂¹+v₃¹+v₁²+v₂²+v₃²+v₁³+v₂³+v₃³=1 (8.9.13)

Using these constraints, a nonlinear minimization of Equation (8.9.4) leads to the following solution:

$$\{ \begin{matrix}\begin{matrix}( {90.0}^{°} , .088 ) / ( {0.0}^{°} , .411 ) / ( - {45.0}^{°} , 0 ) / \\ ( {90.0}^{°} , .501 ) / ( - {45.7}^{°} , 0 ) / ( - {9.5}^{°} , 0 ) /\end{matrix} \\ ( {45.1}^{°} , 0 ) / ( {44.3}^{°} , 0 ) / ( {15.6}^{°} , 0 )\end{matrix} \} \qquad ( 8.9 .14 )$$

which leads to this result for the final laminate:

$$\{ \begin{matrix}{\hat{A}}_{1111}^{lam} = 79.8 \\ {\hat{A}}_{1112}^{lam} = 0 \\ {\hat{A}}_{1122}^{lam} = 2.5 \\ {\hat{A}}_{1212}^{lam} = 5.7 \\ {\hat{A}}_{1222}^{lam} = 0 \\ {\hat{A}}_{2222}^{lam} = 39.9\end{matrix} \} GPa \qquad ( 8.9 .15 )$$

Notice that in this example six of the nine layers had thickness fractions of zero, including all of one material.

Multiple Requirement Design

Consider the possibility that more than one material property is desired in a laminate. For example, a thermal plane obviously requires thermal conductivity but might also require stiffness properties to meet minimum frequency goals. The linear invariant of thermal conductivity, a second order tensor, is

$$\begin{matrix}{\hat{k}}_{ii}^{goal} = {\hat{k}}_{ii}^{lam} \\ {\sum }_{m = 1}^{N} {v}^{m} = 1\end{matrix} \qquad ( 8.10 .1 )$$

The two linear invariants of stiffness, a fourth order tensor, are

$$\begin{matrix}\begin{matrix}{\hat{A}}_{ijij}^{goal} = {\hat{A}}_{ijij}^{lam} \\ {\hat{A}}_{iijj}^{goal} = {\hat{A}}_{iijj}^{lam}\end{matrix} \\ {\sum }_{m = 1}^{N} {v}^{m} = 1\end{matrix} \qquad ( 8.10 .2 )$$

where in each case v^{m} are the thickness fractions of each material. In the case of thermal conductivity two materials are sufficient to design the laminate. Similarly, in the case of stiffness three materials are sufficient. Now, for the combined design problem, four materials are sufficient to solve for the thickness fractions of the required constituent materials (since the thickness fraction equation has been repeated in (8.10.1) and (8.10.2)). Again, to be a feasible solution, all the thickness fractions must be between zero and one for a candidate list of materials.

The strategy for finding layup angles proposed so far has been to minimize the tensor norm of the difference between the goal and laminate properties. This norm is a scalar function given here for thermal conductivity as

$$min \frac{( {\hat{k}}_{ij}^{goal} - {\hat{k}}_{ij}^{lam} ) ( {\hat{k}}_{ij}^{goal} - {\hat{k}}_{ij}^{lam} )}{{\hat{k}}_{ij}^{goal} {\hat{k}}_{ij}^{goal}} \qquad ( 8.10 .3 )$$

and for stiffness properties as

$$min \frac{( {\hat{A}}_{ijkl}^{goal} - {\hat{A}}_{ijkl}^{lam} ) ( {\hat{A}}_{ijkl}^{goal} - {\hat{A}}_{ijkl}^{lam} )}{{\hat{A}}_{ijkl}^{goal} {\hat{A}}_{ijkl}^{goal}} \qquad ( 8.10 .4 )$$

Minimizing both scalars simultaneously as a weighted average, where the relative weights are determined by the designer, allows both design specifications to be realized

$$\begin{matrix}min ( \begin{matrix}{g}^{A} \frac{( {\hat{A}}_{ijkl}^{goal} - {\hat{A}}_{ijkl}^{lam} ) ( {\hat{A}}_{ijkl}^{goal} - {\hat{A}}_{ijkl}^{lam} )}{{\hat{A}}_{ijkl}^{goal} {\hat{A}}_{ijkl}^{goal}} + \\ {g}^{k} \frac{( {\hat{k}}_{ij}^{goal} - {\hat{k}}_{ij}^{lam} ) ( {\hat{k}}_{ij}^{goal} - {\hat{k}}_{ij}^{lam} )}{{\hat{k}}_{ij}^{goal} {\hat{k}}_{ij}^{goal}}\end{matrix} ) \\ {g}^{A} + {g}^{k} = 1\end{matrix} \qquad ( 8.10 .5 )$$

where g^{A} and g^{k} are the weights assigned by the designer to the relative importance of the stiffness and thermal conductivity specifications, respectively.
Numerical Example Using Linear Invariants

The objective is to design a laminate with the following specified stiffnesses and thermal conductivities:

$$\{ \begin{matrix} {\hat{A}}_{1111}^{spec} = 160 \\ {\hat{A}}_{1112}^{spec} = 0 \\ {\hat{A}}_{1122}^{spec} = 4 \\ {\hat{A}}_{1212}^{spec} = 8 \\ {\hat{A}}_{1222}^{spec} = 0 \\ {\hat{A}}_{2222}^{spec} = 80 \end{matrix} \} GPa \{ \begin{matrix}{\hat{k}}_{11}^{spec} = 250 \\ {\hat{k}}_{12}^{spec} = 0 \\ {\hat{k}}_{22}^{spec} = 50 \end{matrix} \} \frac{W}{m - K} \qquad ( 8.10 .6 )$$

where the values have been listed in column format for simplicity but it is understood that they possess a tensor character. Consider that four candidate materials with the following properties exist:

$$T300 E \text{-} glass \\ \{ \begin{matrix}{Q}_{1111}^{1} = 181.8 GPa \\ {Q}_{1112}^{1} = 0 GPa \\ {Q}_{1122}^{1} = 2.90 GPa \\ {Q}_{1212}^{1} = 7.17 GPa \\ {Q}_{1222}^{1} = 0 GPa \\ {Q}_{2222}^{1} = 10.35 GPa \\ {k}_{11}^{1} = 4 \cdot \frac{W}{m - K} \\ {k}_{12}^{1} = 0 \cdot \frac{W}{m - K} \\ {k}_{22}^{1} = 1 \cdot \frac{W}{m - K}\end{matrix} \} \{ \begin{matrix}{Q}_{1111}^{2} = 39.2 GPa \\ {Q}_{1112}^{2} = 0 GPa \\ {Q}_{1122}^{2} = 2.18 GPa \\ {Q}_{1212}^{2} = 4.14 GPa \\ {Q}_{1222}^{2} = 0 GPa \\ {Q}_{2222}^{2} = 8.39 GPa \\ {k}_{11}^{2} = 1 \cdot \frac{W}{m - K} \\ {k}_{12}^{2} = 0 \cdot \frac{W}{m - K} \\ {k}_{22}^{2} = 1 \cdot \frac{W}{m - K} \end{matrix} \} \\ Copper K13D2U \\ \{ \begin{matrix}{Q}_{1111}^{3} = 98.5 GPa \\ {Q}_{1112}^{3} = 0 GPa \\ {Q}_{1122}^{3} = 29.5 GPa \\ {Q}_{1212}^{3} = 34.5 GPa \\ {Q}_{1222}^{3} = 0 GPa \\ {Q}_{2222}^{3} = 98.5 GPa \\ {k}_{11}^{3} = 395 \cdot \frac{W}{m - K} \\ {k}_{12}^{3} = 0 \cdot \frac{W}{m - K} \\ {k}_{22}^{3} = 395 \cdot \frac{W}{m - K} \end{matrix} \} \{ \begin{matrix} {Q}_{1111}^{4} = 552.2 GPa \\ {Q}_{1112}^{4} = 0 GPa \\ {Q}_{1122}^{4} = 1.8 GPa \\ {Q}_{1212}^{4} = 1.8 GPa \\ {Q}_{1222}^{4} = 0 GPa \\ {Q}_{2222}^{4} = 5.7 GPa \\ {k}_{11}^{4} = 425 \cdot \frac{W}{m - K} \\ {k}_{12}^{4} = 0 \cdot \frac{W}{m - K} \\ {k}_{22}^{4} = 2 \cdot \frac{W}{m - K} \end{matrix} \} \qquad ( 8.10 .7 )$$

Solving Equations (8.10.1) and (8.10.2) for the required thickness fractions for a feasible solution yields
v¹=0.57 v²=0.01 v³=0.33 v⁴=0.09 (8.10.8)

Note that these thickness fractions are all positive and between one and zero indicating that the candidate materials constitute a feasible design. The thickness fractions are then used to reduce the tensor norm invariant of the difference between the goal and the laminate, Equation (8.3.6), to a function of the four layup angles (θ¹,θ²,θ³,θ⁴). Note that material three, copper, is isotropic in both stiffness and thermal conductivity, which means that a layup angle has no real meaning. A robust global minimization [22] of the function with equal weights given to each property (g^{A}=g^{k}=0.5) yields a solution
(θ¹=0°,θ²=90°,θ³=90°,θ⁴=0°) (8.10.9)
which leads to this balanced result for the final laminate:

$$\{ \begin{matrix}{\hat{A}}_{1111}^{lam} = 185.8 \\ {\hat{A}}_{1112}^{lam} = 0 \\ {\hat{A}}_{1122}^{lam} = 11.5 \\ {\hat{A}}_{1212}^{lam} = 15.5 \\ {\hat{A}}_{1222}^{lam} = 0 \\ {\hat{A}}_{2222}^{lam} = 39.1\end{matrix} \} GPa \{ \begin{matrix}{\hat{k}}_{11}^{spec} = 169. \\ {\hat{k}}_{12}^{spec} = 0 \\ {\hat{k}}_{22}^{spec} = 131. \end{matrix} \} \frac{W}{m - K} \qquad ( 8.10 .10 )$$

Numerical Example Using Quadratic Invariants

The objective is to design a laminate with the following specified stiffnesses and thermal conductivities:

$$\{ \begin{matrix} {\hat{A}}_{1111}^{spec} = 160 \\ {\hat{A}}_{1112}^{spec} = 0 \\ {\hat{A}}_{1122}^{spec} = 4 \\ {\hat{A}}_{1212}^{spec} = 8 \\ {\hat{A}}_{1222}^{spec} = 0 \\ {\hat{A}}_{2222}^{spec} = 80 \end{matrix} \} GPa \{ \begin{matrix}{\hat{k}}_{11}^{spec} = 250 \\ {\hat{k}}_{12}^{spec} = 0 \\ {\hat{k}}_{22}^{spec} = 50 \end{matrix} \} \frac{W}{m - K} \qquad ( 8.10 .11 )$$

where the values have been listed in column format for simplicity but it is understood that they possess a tensor character. Consider that same four candidate materials are available as in the previous example as given in Equation (8.10.7)

Minimizing Equation (8.10.5), the quadratic invariant, for the required thickness fractions and layup angles simultaneously with equal weights given to each material property (g^{A}=g^{k}=0.5) yields
v¹=0.00 V²=0.49 v³=0.25 v⁴=0.26
(θ¹=8.3°, θ²=90°, θ³=−85°, θ⁴=0.6°) (8.10.12)
which leads to this balanced result for the final laminate:

$$\{ \begin{matrix}{\hat{A}}_{1111}^{lam} = 173.7 \\ {\hat{A}}_{1112}^{lam} = 1.5 \\ {\hat{A}}_{1122}^{lam} = 8.8 \\ {\hat{A}}_{1212}^{lam} = 10.6 \\ {\hat{A}}_{1222}^{lam} = 0 \\ {\hat{A}}_{2222}^{lam} = 45.0 \end{matrix} \} GPa \{ \begin{matrix}{\hat{k}}_{11}^{spec} = 210. \\ {\hat{k}}_{12}^{spec} = 0 \\ {\hat{k}}_{22}^{spec} = 98. \end{matrix} \} \frac{W}{m - K} \qquad ( 8.10 .13 )$$

Strength Design

Laminates are used to support loads and therefore laminate strength must be considered in their design. The force and moment resultants Nᵢⱼ and Mᵢⱼ of classical plate theory are related to the midplane strains and curvatures εₖₗ^{o} and κᵢⱼ by the matrix construction

$$\{ \begin{matrix}{N}_{ij} \\ {M}_{ij}\end{matrix} \} = [ \begin{matrix}{A}_{ijkl} & {B}_{ijkl} \\ {B}_{ijkl} & {D}_{ijkl}\end{matrix} ] \{ \begin{matrix}{ɛ}_{kl}^{o} \\ {κ}_{kl}\end{matrix} \} \qquad ( 8.11 .1 )$$

Point strength analysis of a laminate inverts the above relationship and uses applied force and moments determined from external loads to solve for the midplane strains and curvatures, from which stresses and strains in individual plies are found. For symmetric laminates Bᵢⱼₖₗ=0 and the stresses in body coordinates of the laminate are
\overline{σ}ᵢⱼ^{m}=\overline{Q}ᵢⱼₖₗ^{m}(a_{klpq}N_{pq}+z^{m}d_{klpq}M_{pq}) (8.11.2)
where a_{klpq} and d_{klpq} are inverses of the in-plane and bending stiffness tensors. If invariants of the material properties are to be used in the design of the laminate, then inversion of the constituent invariants must be understood as in the CTE problem. Furthermore, the stresses in each ply calculated in (8.11.2) must be compared to ply strengths through some form of failure criterion.

Laminate failure may be inferred as either first ply failure or some form of progressive failure. The stresses in each ply calculated in (8.11.2) are compared to ply strengths through some form of failure criteria. Two criteria in common use are the Maximum Stress and Tsai-Wu Quadratic Criterion.

Maximum Stress Criteria

The Maximum Stress Criteria are based on phenomenological models of material failure in that failure is assumed to occur whenever the stress exceeds the measured strength in that direction. The model is phenomenological in the sense that each strength is presumed to be associated with a particular mode of failure. Thus,
X^{c}<σ₁₁<X^{t}
Y^{c}<σ₂₂<Y^{t}
σ₁₂≦S (8.11.3)
where X^{t}, X^{c} are in-plane longitudinal strengths in tension and compression, Y^{t}, Y^{c} transverse in-plane strengths in tension and compression, and S the in-plane shear strength.
Tsai-Wu Quadratic Criteria

The Tsai-Wu theory assumes that complex states of stress will interact. Thus, an empirical model of failure is assumed where the coefficients Fᵢⱼ and Fᵢ can be determined from uniaxial strength data (for the most part). As shown here, the criterion is not given in tensor notation, rather in contracted notation.
Fᵢⱼσᵢσⱼ+Fᵢσᵢ=1 (8.11.4)
Strength Design

Stress is a tensor quantity that may be calculated from Equation (8.11.2) on a ply by ply basis. Failure of the ply is determined by rotating the stresses into the ply coordinates and then comparing those stresses with the strength of the material via criteria such as (8.11.3) or (8.11.4). The strength of the entire laminate is sometimes inferred from the strength of the weakest ply under the given loads, which is known as first ply failure. It is not clear whether either of these criteria or strength in general actually constitute tensor quantities. An invariant of stress may or may not be related to an invariant of strength. If this can be shown, then this would be a new approach to strength prediction. The specification for strength might look like

$${\{ {σ}_{ij}^{m} \}}^{spec} = \{ \begin{matrix}{X}^{c} < {σ}_{11}^{m} < {X}^{t} & {σ}_{12}^{m} \leq S \\ {σ}_{12}^{m} \leq S & {Y}^{c} < {σ}_{12}^{m} < {Y}^{t}\end{matrix} \} \qquad ( 8.11 .5 )$$

Smart Material Design

Smart materials are those that act as sensors or actuators [24, 25], frequently combined in structure or other material system.

Piezoelectric Smart Material Design

The constitutive relations for piezoelectric ceramic materials may be given by
εᵢⱼ=Sᵢⱼₖₗ^{E}σₖₗ+d_{qij}E_{q}
Dᵢ=dᵢₖₗσₖₗ+ξᵢⱼ^{σ}Eⱼ (8.12.1)
where εᵢⱼ are strain tensor components, Sᵢⱼₖₗ^{E} the elastic compliance tensor components for a constant electric field, σₖₗ are stress tensor components, dₖᵢⱼ are piezoelectric strains components, Eₖ the electric field components, Dᵢ the electric displacement components, and ξᵢⱼ^{σ} the permittivity components for a constant elastic stress [24]. Note that the equations are coupled through both the stress and electric fields. Thus, an applied load will give rise to an electric field and conversely, an applied electric field will give rise to an elastic stress, which implies that these materials can be used as both sensors and actuators, respectively. This example discusses the design of these materials as an actuator although it is clear that both kinds are intended use may be designed.

Taking the double dot product of the first equation in (8.12.1) with the elastic stiffness tensor Iᵢⱼₖₗ^{E} (the inverse of Sᵢⱼₖₗ^{E})
Cᵣₛᵢⱼ^{E}εᵢⱼ=Cᵣₛᵢⱼ^{E}(Sᵢⱼₖₗ^{E}σₖₗ+d_{qij}E_{q}) (8.12.2)

Or, rearranging, and exchanging dummy indices,
σᵢⱼ^{m}=Cᵢⱼₖₗ^{m}(εₖₗ^{m}−d_{qkl}^{m}E_{q}^{m}) (8.12.3)
where the superscript m refers to the ply and material as in previous examples, and the superscript E has been dropped just for simplicity of notation. Invoking the thin plate assumptions of plate theory (whereby the Cᵢⱼₖₗ^{m} are replace by the plate theory equivalent Qᵢⱼₖₗ^{m}), rotating all properties to a common coordinate system (overbar), and using the displacement assumptions of plate theory (Equation (5.3.4)), yields
\overline{σ}ᵢⱼ^{m}=\hat{Q}ᵢⱼₖₗ^{m}(εₖₗ⁰+zκₖₗ−\overline{d}_{qkl}^{m}\overline{E}_{q}^{m}) (8.12.4)

Integrating over the thickness of the plate to find force and moment resultants yields expressions identical to standard plate theory with the addition of piezoelectric force and moment resultants.

Force Nᵢⱼ and moment Mᵢⱼ resultants for the plate are obtained by integrating Equation (5.3.1), the stress-strain relation, together with the strain assumption Equation (5.3.4), yielding

$${N}_{ij} = {\int }_{- t / 2}^{t / 2} {\overline{σ}}_{ij}^{m} ⅆ z = {\int }_{- t / 2}^{t / 2} {\overline{Q}}_{ijkl}^{m} ( {ɛ}_{kl}^{0} + z {κ}_{kl} - {\overline{d}}_{qkl}^{m} ) ⅆ z = {A}_{ijkl} {ɛ}_{kl}^{0} + {B}_{ijkl} {κ}_{kl} - {N}_{ij}^{P} \\ {M}_{ij} = {\int }_{- t / 2}^{t / 2} {\overline{σ}}_{ij}^{m} z ⅆ z = {\int }_{- t / 2}^{t / 2} {\overline{Q}}_{ijkl}^{m} ( {ɛ}_{kl}^{0} + z {κ}_{kl} - {\overline{d}}_{qkl}^{m} ) z ⅆ z = {B}_{ijkl} {ɛ}_{kl}^{0} + {D}_{ijkl} {κ}_{kl} - {M}_{ij}^{P} \qquad ( 8.12 .5 )$$

where the stiffnesses Aᵢⱼₖₗ, Bᵢⱼₖₗ, Dᵢⱼₖₗ are the same as in Equation (5.3.6), and the piezoelectric force and moment resultants are

$${N}_{ij}^{P} = {\sum }_{m = 1}^{N} {\int }_{{z}_{m}}^{{z}_{m + 1}} {\overline{Q}}_{ijkl}^{m} {\overline{d}}_{qkl}^{m} {\overline{E}}_{q}^{m} ⅆ z \\ {M}_{ij}^{P} = {\sum }_{m = 1}^{N} {\int }_{{z}_{m}}^{{z}_{m + 1}} {\overline{Q}}_{ijkl}^{m} {\overline{d}}_{qkl}^{m} {\overline{E}}_{q}^{m} z ⅆ z \qquad ( 8.12 .6 )$$

For the sake of simplicity the laminate will be assumed to be symmetric so that Bᵢⱼₖₗ=0, although this is not necessary. In the absence of applied mechanical forces and moments, the laminate in-plane strains and curvatures arising as a result of piezoelectric force and moment resultants can be found by solving Equation (8.12.5) thusly
εᵢⱼ⁰=aᵢⱼₖₗNₖₗ^{P}
κᵢⱼ=dᵢⱼₖₗMₖₗ^{P} (8.12.7)
where aᵢⱼₖₗ,dᵢⱼₖₗ are the inverses of Aᵢⱼₖₗ,Dᵢⱼₖₗ, respectively. These equations describe the analysis of smart piezoelectric materials.
Piezoelectric Smart Material Design Objective

The objective, given an applied electric field E_{q}, is to design a specified piezoelectric in-plane strain or bending curvature response of a laminate, as specified by

$${ɛ}_{ij}^{spec} = ( \begin{matrix}{ɛ}_{11}^{spec} & {ɛ}_{12}^{spec} \\ {ɛ}_{12}^{spec} & {ɛ}_{22}^{spec}\end{matrix} ) \\ {κ}_{ij}^{spec} = ( \begin{matrix}{κ}_{11}^{spec} & {κ}_{12}^{spec} \\ {κ}_{12}^{spec} & {κ}_{22}^{spec}\end{matrix} ) \qquad ( 8.12 .8 )$$

Both of these design problems are similar to the thermal expansion design problem in that the two material properties, piezoelectric strains d_{qij}^{m} and plane stress reduced stiffnesses Qᵢⱼₖₗ^{m}, are involved as well as the inversion of the stiffness tensor. As a consequence, setting the invariants of the specified requirements equal to the invariants of the laminate, together with the requirement that thickness fractions be positive and sum to one, does not create two linear equations, for example

$${ɛ}_{ii}^{spec} = {ɛ}_{ii}^{lam} \\ {\sum }_{m = 1}^{N} {v}^{m} = 1 {v}^{m} = \frac{{t}^{m}}{h} . \qquad ( 8.12 .9 )$$

Nevertheless, the fact that two equations are available supports the conjecture that, if the number of materials N=2, a feasible solution can be found.

Layup angles and thickness fractions are found simultaneously by minimizing the tensor norm invariant of the difference between the specified tensor and the candidate laminate.

$$min \frac{( {ɛ}_{ij}^{spec} - {ɛ}_{ij}^{lam} ) ( {ɛ}_{ij}^{spec} - {ɛ}_{ij}^{lam} )}{{ɛ}_{ij}^{spec} {ɛ}_{ij}^{spec}} \\ min \frac{( {κ}_{ij}^{spec} - {κ}_{ij}^{lam} ) ( {κ}_{ij}^{spec} - {κ}_{ij}^{lam} )}{{κ}_{ij}^{spec} {κ}_{ij}^{spec}} \qquad ( 8.12 .10 )$$

These are the equations for the design of smart material laminate.

Transverse Shear Deformation Material Design

The shear modulus G for an isotropic material is related to the tensile modulus E by

$$G = \frac{E}{2 ( 1 + υ )} \qquad ( 8.13 .1 )$$

where v is Poisson's ratio. Thus, the shear modulus is roughly half the tensile modulus. In contrast, the transverse shear modulus G₁₁₃₃ of a unidirectional composite tape is often a factor of 20 to 40 times less than the comparable tensile modulus E₁₁₁₁. Classical plate and beam theories were developed on the assumption that deformation due to transverse shearing stresses is small. While the stresses developed in a plate laminated from orthotropic materials may still be small compared to in-plane stresses, the contribution to the overall deformation will increase due to the reduced stiffness. The transverse shear deformation plate theories discussed here address this difficulty through modifications to the displacement assumptions.
First Order Shear Deformation Theory

First order shear deformation theory [13] retains the classical assumption that plane sections remain plane, but relaxes the requirement that normals to the plate midsurface remain normal. The rotation of a line originally perpendicular to the plate midsurface is given as ψₓ with respect to the x axis and ψ_{y} with respect to the y axis. The displacement assumptions are, therefore
u=u^{o}+zψₓ
v=v^{o}+zψ_{y}
w=w^{o} (8.13.2)

The constitutive law relating transverse shear stresses to transverse shear strains for an orthotropic material is

$$\{ \begin{matrix}{σ}_{23} \\ {σ}_{13}\end{matrix} \} = [ \begin{matrix}{C}_{2323} & 0 \\ 0 & {C}_{1313}\end{matrix} ] \{ \begin{matrix}{γ}_{23} \\ {γ}_{13}\end{matrix} \} \qquad ( 8.13 .3 )$$

In terms of plane stress reduced stiffnesses for a ply of arbitrary orientation

$$\{ \begin{matrix}{\overline{σ}}_{23} \\ {\overline{σ}}_{13}\end{matrix} \} = [ \begin{matrix}{\overline{Q}}_{2323} & {\overline{Q}}_{2313} \\ {\overline{Q}}_{2313} & {\overline{Q}}_{1313}\end{matrix} ] \{ \begin{matrix}{\overline{γ}}_{23} \\ {\overline{γ}}_{13}\end{matrix} \} \qquad ( 8.13 .4 )$$

Integrating over the thickness of the plate yields a relation between the transverse shear resultants Q₂₃ and Q₁₃ and the transverse shear strains in terms of the plate transverse shear stiffness A₂₃₂₃, A₁₃₁₃, A₂₃₁₃. A factor k has been added which is known as the shear correction factor. This factor is necessary since the displacement assumption implies that nonzero shear strains will occur on the plate surfaces. The transverse shear strains are presumed constant across the thickness of the plate. This is clearly not correct, so the correction factor k, which can be calculated in a number of ways, is added to give an average value for the shear strains.

The transverse shear resultants are defined by

$$\{ \begin{matrix}{Q}_{23} \\ {Q}_{13}\end{matrix} \} = {\int }_{- \frac{h}{2}}^{\frac{h}{2}} \{ \begin{matrix}{\overline{σ}}_{23} \\ {\overline{σ}}_{13}\end{matrix} \} ⅆ z = {\int }_{- \frac{h}{2}}^{\frac{h}{2}} k [ \begin{matrix}{\overline{Q}}_{2323} & {\overline{Q}}_{2313} \\ {\overline{Q}}_{2313} & {\overline{Q}}_{1313}\end{matrix} ] \{ \begin{matrix}{\overline{γ}}_{23} \\ {\overline{γ}}_{13}\end{matrix} \} ⅆ z \qquad ( 8.13 .5 )$$

Defining the transverse shear stiffnesses by

$${A}_{2323} = {\sum }_{m = 1}^{N} {Q}_{2323}^{m} ( {z}^{m} - {z}^{m - 1} ) \\ {A}_{1313} = {\sum }_{m = 1}^{N} {Q}_{1313}^{m} ( {z}^{m} - {z}^{m - 1} ) \\ {A}_{2313} = {\sum }_{m = 1}^{N} {Q}_{2313}^{m} ( {z}^{m} - {z}^{m - 1} ) \qquad ( 8.13 .6 )$$

So that

$$\{ \begin{matrix}{Q}_{23} \\ {Q}_{13}\end{matrix} \} = k [ \begin{matrix}{A}_{2323} & {A}_{2313} \\ {A}_{2313} & {A}_{1313}\end{matrix} ] \{ \begin{matrix}{\overline{γ}}_{23} \\ {\overline{γ}}_{13}\end{matrix} \} \qquad ( 8.13 .7 )$$

Higher Order Shear Deformation Theories

Higher order shear deformation theories are also possible. One [13], for example, derives inspiration from the cubic relationship seen in the elasticity beam solution. The in-plane displacements are assumed to be cubic functions of the transverse displacement. Boundary conditions on the plate surface are then used to reduce the general form of the equations to five functions which are similar to the first order theory.
u=u^{o}+zψₓ+z²ξₓ+z³ζₓ
v=v^{o}+zψ_{y}+z²ξ_{y}+z³ζ_{y}
w=w^{o} (8.13.8)

It is clear that transverse shear stiffnesses similar to Equation (8.13.7) can be developed according to the nuances of the various theories.

Invariant Based Design using Shear Deformation Theories

There are still two linear invariants of fourth order tensors given the symmetry properties of elastic stiffnesses. Extending the definition to three dimensions yields, for example
Aᵢⱼᵢⱼ=A₁₁₁₁+A₂₂₂₂+A₃₃₃₃+2A₁₂₁₂+2A₁₃₁₃+2A₂₃₂₃
Aᵢᵢⱼⱼ=A₁₁₁₁+A₂₂₂₂+A₃₃₃₃+2A₁₁₂₂+2A₁₁₃₃+2A₂₂₃₃ (8.13.9)

Some terms, such as A₃₃₃₃, A₁₁₃₃, A₂₂₃₃ have yet to be defined in the context of a two dimensional laminated plate theory. However, the transverse shear stiffness terms A₂₃₂₃ and A₁₃₁₃ do appear in the first equation. Therefore, design of laminated plates using the principles of invariant based design is straightforward and obvious.

Practical Laminates

The above examples have tacitly assumed that thickness fractions or thicknesses of constituent materials are continuous variables. On the other hand, practical laminates are constructed from materials that typically come in standard sizes. Optimization and minimization methods tend to work better with continuous variables. One approach to the problem of finding the best possible practical laminate is to find the optimum solution, then look for the closest viable solution. On the other hand, some optimization schemes are designed around integer variables, particularly sorting and route finding routines. An integer approach may be required for one of the hardest problems in composite design, when to add or subtract materials or plies.

Fuzzy Laminate Design

The examples shown have assumed that the specified tensor material properties are known exactly. That is, every value of a desired property is known or can be specified. Practically, this may not always be the case. Some components of the desired material property tensor may be known better than others. For example, the designer of a strut for an optical bench may desire that the axial thermal expansion of the strut be controlled very closely whereas the circumferential thermal expansion is relatively unimportant and any value is acceptable. Likewise, the axial stiffness of the strut may be very important and other components less so. Fuzzy design specifies only those properties that are highly desirable and allows remaining components to vary over acceptable ranges.

Variable Ranges

There are natural constraints or limits on the ranges of material properties even when they are independent. For example, Poisson's ratio for isotropic materials ranges from zero to one-half even though it is independent of Young's modulus. Energy considerations are often invoked to establish the ranges. Poisson's ratio for orthotropic materials has a greater range, depending on the values of other independent material properties. Allowing a user complete freedom to select every value of a tensor may be energetically inadmissible. Therefore, an incomplete specification of desired properties by a user should be coupled with admissible ranges for the unspecified properties derived from whatever input data is provided to suggest values for the remaining requirements.

Restrictions on Elasticity Constants for Orthotropic Materials

The elastic compliances Sᵢⱼₖₗ are related to ordinary engineering Young's modulus, Poisson's ratio, and shear modulus Eᵢⱼₖₗ,vᵢⱼₖₗ,Gᵢⱼₖₗ as shown in Equation (8.15.1)

$${S}_{1111} = \frac{1}{{E}_{1111}} {S}_{1122} = - \frac{{v}_{1122}}{{E}_{1111}} {S}_{2323} = \frac{1}{{G}_{2323}} \\ {S}_{2222} = \frac{1}{{E}_{2222}} {S}_{1133} = - \frac{{v}_{1133}}{{E}_{1111}} {S}_{1313} = \frac{1}{{G}_{1313}} \\ {S}_{3333} = \frac{1}{{E}_{3333}} {S}_{2233} = - \frac{{v}_{2233}}{{E}_{2222}} {S}_{1212} = \frac{1}{{G}_{1212}} \qquad ( 8.15 .1 )$$

Requiring that a single applied stress result in a strain of the same sign [27] implies that some of the compliances are positive valued.
S₁₁₁₁, S₂₂₂₂, S₃₃₃₃, S₂₃₂₃, S₁₃₁₃, S₁₂₁₂>0 (8.15.2)

This, in turn, implies that the following engineering constants are also positive
E₁₁₁₁, E₂₂₂₂, E₃₃₃₃, G₂₃₂₃, G₁₃₁₃, G₁₂₁₂>0 (8.15.3)

Likewise, requiring that a single applied strain along a principal direction results in a stress of like sign implies that the elastic stiffness tensor Cᵢⱼₖₗ=Sᵢⱼₖₗ⁻¹ have the following positive values
C₁₁₁₁, C₂₂₂₂, C₃₃₃₃, C₂₃₂₃, C₁₃₁₃, C₁₂₁₂>0 (8.15.4)
which, in turn, implies that Cᵢⱼₖₗ and Sᵢⱼₖₗ are positive definite. Using these results, relationships between the tensor components such as Equation (8.15.5) can be established.
|S₂₃₂₃|<\sqrt{S₂₂₂₂S₃₃₃₃}
|S₁₃₁₃|<\sqrt{S₁₁₁₁S₃₃₃₃}
|S₁₂₁₂|<\sqrt{S₁₁₁₁S₂₂₂₂} (8.15.5)
Bounds on Design

Relationships such as Equations (8.15.1) through (8.15.5) establish bounds on admissible values of tensor components. These bounds can be used in two ways: (1) to verify that a specified material property tensor is, in fact, physically possible, and (2) to provide bounds or ranges for unspecified components given and incomplete specification.

Laminate Design Wizard

The Laminate Design Wizard is the software package incorporating the method for the design of laminated composite materials discussed herein. The package will provide material options, combinations and layup angles satisfying the specified material requirements. With suitable hooks into the finite element code, the Wizard will also facilitate material data entry into the finite element model.

User Interface

Ideally, a user would be able to completely specify every component of the material property tensors they are designing. The Wizard must be capable of requesting input within the user's context as well as being capable of functioning with incomplete input data.

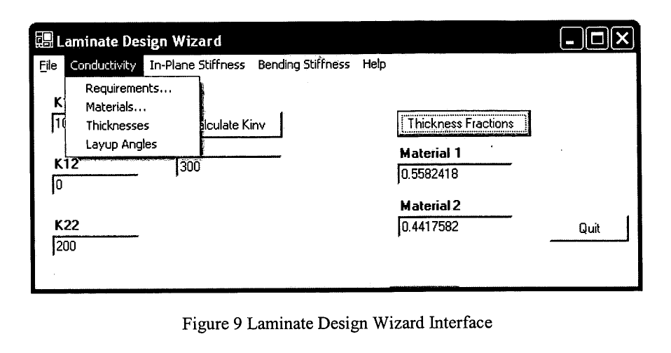

The user interface for the Laminate Design Wizard is under development. A possible look is shown in FIG. 9, where drop down menus for various material properties are shown together with text box input for material requirements and button selections controlling the calculation of desired quantities.

What is claimed is:

1. A method for efficient design of a specified laminated composite material having tensor properties, composed of a set of candidate materials having tensor properties, each of the candidate materials having a thickness or thickness fraction, stacking sequence, and layup angle to be determined, comprising the following steps:
Calculating tensor invariants of the specified laminated composite material,
Calculating tensor invariants of the candidate materials,
Forming a set of relationships between the tensor invariants of the specified laminated composite material and the tensor invariants of the candidate materials,
Determining from the set of relationships an optimal set of candidate materials, thicknesses or thickness fractions, stacking sequence, and layup angles.
